(19) United States
(12) Patent Application Publication
(10) Pub. No.: US 2007/0280223 A1
(43) Pub. Date: Dec. 6, 2007

(54) Hybrid data switching for efficient packet processing

(75) Inventors: Ping Pan, San Jose, CA (US); Alex Shaham Dadnam, San Ramon, CA (US); Kim Holmes, San Jose, CA (US)

Correspondence Address: VAN PELT, YI & JAMES LLP, 10050 N. FOOTHILL BLVD #200, CUPERTINO, CA, 95014, US

(73) Assignee: Hammerhead Systems, Inc.

(21) Appl. No.: 11/787,664

(22) Filed: Apr. 16, 2007

Related U.S. Application Data
(60) Provisional application No. 60/792,078, filed on Apr. 14, 2006.

(51) Int. Cl. H04Q 11/00

(52) U.S. Cl. 370/360

(57) ABSTRACT

A data networking system includes a physical interface module of a first type, configured to transfer data traffic that meets a first requirement, a physical interface module of a second type, configured to transfer data traffic that meets a second requirement, the second requirement being different from the first requirement, a packet switch, and a hybrid switching module configured to transfer data between the first physical interface module and the packet switch, and to transfer data between the second physical interface module and the packet switch.

### CROSS REFERENCE TO OTHER APPLICATIONS

This application claims priority to U.S. Provisional Patent Application No. 60/792,078, entitled A HYBRID SWITCHING METHOD FOR EFFICIENT PACKET PROCESSING, filed Apr. 14, 2006 which is incorporated herein by reference for all purposes.

### BACKGROUND OF THE INVENTION

Different types of networks providing the same or similar services often have different requirements such as different data rates. A typical networking switching device such as a router or a switch is usually design to fulfill a specific requirement by a specific type of service. The cost of supporting the service tends to increase for services with more stringent requirements. In an environment where data traffic with different service requirements is aggregated and processed, the operator can configure multiple devices suitable for handling different types of traffic and fulfilling these requirements. The management of multiple devices leads to increased system complexity and higher maintenance cost. Alternatively, the operator can overprovision the system. In other words, the operator can use a high performance system that fulfills the most stringent service requirement. This solution, however, typically leads to wasted bandwidth and processing power, and is not practical for most service providers. It would be useful, therefore, to develop a switching system that would meet these requirements in a cost effective way. It would also be desirable if such a system is more configurable and flexible than the typical devices available today.

### BRIEF DESCRIPTION OF THE DRAWINGS

Various embodiments of the invention are disclosed in the following detailed description and the accompanying drawings.

FIG. 1 is a block diagram depicting one embodiment of a network switch in accordance with the present invention.

FIG. 2A is a flowchart depicting one embodiment of a process for the ingress flow of data through a network switch.

FIG. 2B is a flowchart depicting one embodiment of a process for the egress flow of data through a network switch.

FIG. 3A is a flowchart depicting one embodiment of a process for mapping link channel data into virtual channel slots.

FIG. 3B is a flowchart depicting one embodiment of a process for extracting payload packets.

FIG. 3C is a flowchart depicting one embodiment of a process for mapping packet data into virtual channel slots.

FIG. 3D is a flowchart depicting one embodiment of a process for mapping virtual channel slot data into link channels.

FIG. 4 is a flowchart depicting one embodiment of a process for a TSI switch to map slot data into outgoing slots.

FIG. 5 is a flowchart depicting one embodiment of a process for a TSI switch to forward slots.

FIG. 6 is a flowchart depicting an alternate embodiment of a process for the ingress flow of data through a network switch.

FIG. 7 is a flowchart depicting an alternate embodiment of a process for the egress flow of data through a network switch.

FIG. 8 is a block diagram depicting one embodiment of a mid-plane multiple card architecture for a network switch.

FIG. 9 is a block diagram depicting one embodiment of a control module.

FIG. 10 is a block diagram depicting one embodiment of a link interface.

FIG. 11 is a block diagram depicting an alternate embodiment of a link interface.

FIG. 12 is a block diagram depicting one embodiment of a processing engine.

FIG. 13 is a block diagram depicting one embodiment of a combined fabric and switch card.

FIG. 14 is a block diagram depicting one embodiment of a TSI switch.

FIG. 15 is a block diagram illustrating a hybrid switching system embodiment.

FIG. 16 is a block diagram illustrating an embodiment of a hybrid switching system.

FIG. 17 is a block diagram illustrating an example of a hybrid switching system in greater detail.

FIG. 18 is a layout diagram illustrating an example layout of a hybrid switching system embodiment.

FIG. 19 is a block diagram illustrating another embodiment of a hybrid switching system.

FIG. 20 is a flowchart illustrating an embodiment of a process for configuring a hybrid switching system.

FIG. 21 is a block diagram illustrating in greater detail an embodiment of a hybrid switching system that includes a universal I/O switch.

FIG. 22 is a flowchart illustrating an embodiment of a process for data flow through the hybrid switching system 2100.

FIG. 23 is another layout diagram illustrating an example layout of another hybrid system embodiment.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

### Pooling Switch

Technology for efficiently utilizing resources within a network switch is described. One implementation of a network pooling switch employs a mid-plane architecture that allows data to be directed between any link interface and any processing engine. In one implementation, each link interface can have a single data stream or a channelized data stream. Each channel of data from a link interface can be separately directed to any processing engine. Similarly, each channel of data from a processing engine can be separately directed to any link interface. In one embodiment, each processing engine in the network switch has the ability to service all of the protocols from the layers of the OSI model that are supported by the switch and not handled on the link interfaces. This allows the switch to allocate processing engine resources, regardless of the protocols employed in the data passing through the switch.

One embodiment of a pooling switch includes link interfaces, processing engines, a switched fabric between the processing engines, and a switch between the link interfaces and processing engines. In one implementation, the switch between the link interfaces and processing engines is a time slot interchange (“TSI”) switch. An ingress link interface receives incoming data from a physical signaling medium. The ingress link interface forwards incoming data to the TSI switch. The TSI switch directs the data to one or more ingress processing engines for processing, such as forwarding at the Layer 2 or Layer 3 level of the OSI model. In one implementation, the TSI switch performs Time Division Multiplexing (“TDM”) switching on data received from each link interface—separately directing each time slot of incoming data to the proper ingress processing engine. In an alternate embodiment, the TSI switch is replaced by a packet switch. The information exchanged between link interfaces and processing engines is packetized and switched through the packet switch.

The ingress processing engine sends data to the packet switch fabric, which directs packets from the ingress processing engine to one or more egress processing engines for further processing and forwarding to the TSI switch. The TSI switch directs the data to one or more egress link interfaces for transmission onto a physical medium. One implementation of the TSI switch performs TDM switching on data streams received from each processing engine—separately directing each time slot of incoming data to the proper egress link interface. In an alternate embodiment, the TSI switch is replaced by a packet switch that performs packet switching.

The switch between the link interfaces and processing engines can be any multiplexing switch—a switch that multiplexes data from multiple input interfaces onto a single output interface and demultiplexes data from a single input interface to multiple output interfaces. The above-described TSI switch and packet switch are examples of a multiplexing switch.

In one example, the TSI switch receives data from link interfaces and processing engines in the form of SONET STS-48 frames. The TSI switch has the ability to switch time slots in the SONET frame down to the granularity of a single Synchronous Transport Signal-1 (“STS-1”) channel. In alternate embodiments, the TSI switch can switch data at a higher or lower granularity. Further implementations of the TSI switch perform virtual concatenation—switching time slots for multiple STS-1 channels that operate together as a higher throughput virtual channel, such as a STS-3 channel.

The operation of the TSI switch and protocol independence of the processing engines facilitates bandwidth pooling within the network switch. When a processing engine becomes over utilized, a channel currently supported by the processing engine can be diverted to any processing engine that is not operating at full capacity. This redirection of network traffic can be performed at the STS-1 channel level or higher. Similar adjustments can be made when a processing engine or link interface are under utilized. Bandwidth pooling adjustments can be made when the network switch is initialized and during the switch's operation. The pooling switch also provides efficient redundancy—a single processing engine can provide redundancy for many other processing engines, regardless of the protocols embodied in the underlying data Any processing engine can be connected to any channel on any link interface—allowing any processing engine in the network switch to back up any other processing engine in the switch. This easily facilitates the implementation of 1:1 or 1:N processing engine redundancy. In one implementation, the efficient distribution of resources allows for a 2:1 ratio of link interfaces to processing engines, so that each link interface has redundancy and no processing engine is required to sit idle.

Techniques described herein can be accomplished using hardware, software, or a combination of both hardware and software. The software is stored on one or more processor readable storage media including hard disk drives, CD-ROMs, DVDs, optical disks, floppy disks, tape drives, RAM, ROM or other suitable storage devices. In alternative embodiments, some or all of the software can be replaced by dedicated hardware including custom integrated circuits, gate arrays, FPGAs, PLDs, and special purpose computers. In one embodiment, software is used to program one or more processors, including microcontrollers and other programmable logic. The processors can be in communication with one or more storage devices, peripherals and/or communication interfaces.

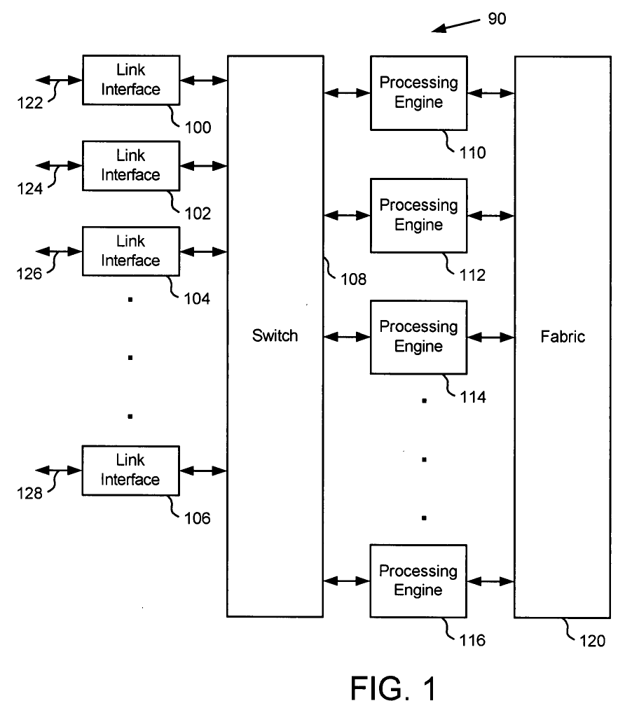

FIG. 1 is a block diagram depicting one embodiment of a pooling switch. Pooling switch 90 implements a mid-plane architecture to switch packets between multiple signaling mediums. Switch 90 supports multiple physical layer protocols in Layer 1 of the OSI model. Switch 90 also supports one or more higher-level protocols corresponding to Layer 2, Layer 3, and above in the OSI model. Switch 90 provides networking services that control the flow of data through switch 90.

Switch 90 can be any type of network switch in various embodiments. In one embodiment, switch 90 is a network edge switch that provides Frame Relay, Gigabit Ethernet, Asynchronous Transfer Mode (“ATM”), and Internet Protocol (“IP”) based services. In one example, switch 90 operates as a Provider Edge (“PE”) Router implementing a virtual private network—facilitating the transfer of information between Customer Edge Routers that reside inside a customer's premises and operate as part of the same virtual private network. In another embodiment, switch 90 is a network core switch that serves more as a data conduit.

FIG. 1 shows that switch 90 has a mid-plane architecture that includes link interfaces 100, 102, 104, and 106, processing engines 110, 112, 114, and 116, switch 108, and fabric 120. In different embodiments, switch 90 can include more or less link interfaces and processing engines. In one embodiment, switch 90 includes 24 link interfaces and 12 processing engines. The link interfaces and processing engines are coupled to switch 108, which switches data between the link interfaces and processing engines. The processing engines are also coupled to fabric 120, which switches data between processing engines. In one implementation, fabric 120 is a switched fabric that switches packets between processing engines. In an alternative implementation, fabric 120 is replaced with a mesh of mid-plane traces with corresponding interfaces on the processing engines.

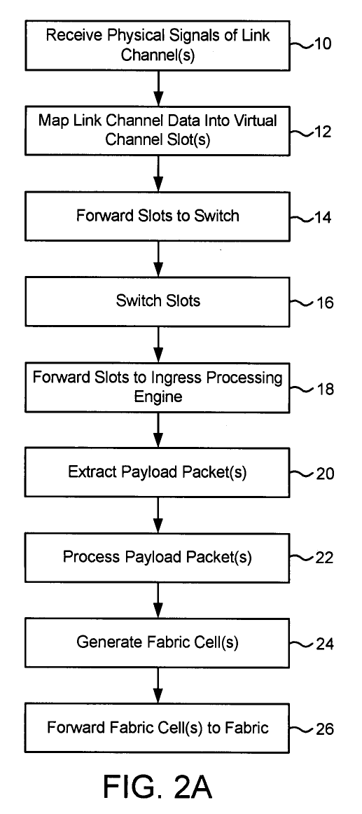

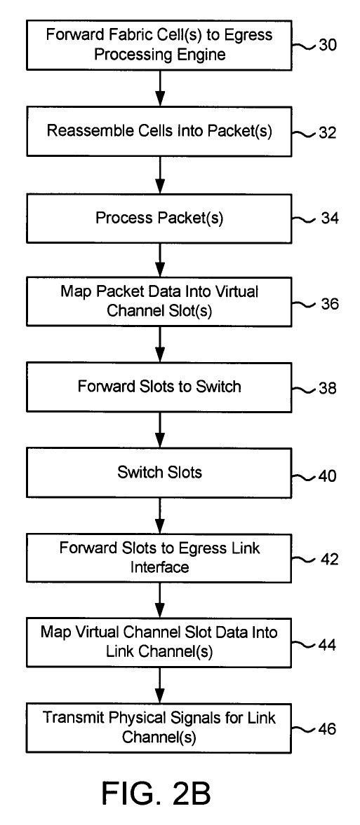

During ingress, data flows through an ingress link interface to switch 108, which switches the data to an ingress processing engine. In one implementation, switch 108 is a multiplexing switch, such as a time slot based switch or packet based switch. The ingress processing engine processes the data and forwards it to an egress processing engine through fabric switch 120. In one implementation, the ingress processing engine employs Layer 2 and Layer 3 lookups to perform the forwarding. The egress processing engine performs egress processing and forwards data to switch 108. Switch 108 switches the data to an egress link interface for transmission onto a medium. More details regarding the ingress and egress flow of data through switch 90 are provided below with reference to FIGS. 2A, 2B, 6, and 7.

Each link interface exchanges data with one or more physical networking mediums. Each link interface exchanges data with the mediums according to the Layer 1 physical signaling standards supported on the mediums. In some embodiments, a link interface also performs a portion of Layer 2 processing, such as MAC framing for Gigabit Ethernet.

In one example, link interfaces 100 and 106 interface with mediums 122 and 128, respectively, which carry STS-48 SONET over OC-48; link interface 102 interfaces with medium 124, which carries channelized SONET over OC-48, such as 4 STS-12 channels; and link interface 104 interfaces with medium 126, which carries Gigabit Ethernet. In various embodiments, many different physical mediums, physical layer signaling standards, and framing protocols can be supported by the link interfaces in switch 90.

The processing engines in switch 90 deliver the services provided by switch 90. In one implementation, each processing engine supports multiple Layer 2, Layer 3, and higher-level protocols. Each processing engine in switch 90 processes packets or cells in any manner supported by switch 90—allowing any processing engine to service data from any medium coupled to a link interface in switch 90. In one embodiment, processing engine operations include Layer 2 and Layer 3 switching, traffic management, traffic policing, statistics collection, and operation and maintenance (“OAM”) functions.

In one implementation, switch 108 is a TSI switch that switches data streams between the link interfaces and processing engines. In one embodiment, TSI switch 108 switches time slots of data between link interfaces and processing engines. In one implementation, each time slot can support a single STS-1 channel. One version of TSI switch 108 interfaces with link interfaces and processing engines through TSI switch ports. During ingress, an ingress link interface maps incoming data into a set of time slots and passes the set of time slots to an incoming TSI switch port in TSI switch 108. In one implementation, TSI switch 108 supports an incoming set of time slots with 48 unique slots, each capable of carrying bandwidth for an STS-1 channel of a SONET frame. In one such embodiment, TSI switch 108 receives the incoming set of time slots on an incoming TSI switch port. In different embodiments, different time slot characteristics can be employed. TSI switch 108 switches the received time slots into outgoing time slots for delivery to ingress processing engines. TSI switch 108 delivers outgoing time slots for each ingress processing engine through an outgoing TSI switch port associated with the respective ingress processing engine.

During egress, an egress processing engine maps egress data into time slots and passes the time slots to TSI switch 108, which receives the time slots into an incoming TSI switch port. TSI switch 108 maps the received time slots into outgoing time slots for delivery to egress link interfaces through outgoing TSI switch ports. In one implementation, TSI switch 108 includes the following: (1) an incoming TSI switch port for each ingress link interface and each egress processing engine, and (2) an outgoing TSI switch port for each ingress processing engine and each egress link interface. When a link interface or processing engine performs both ingress and egress operations, TSI switch 108 includes an incoming TSI switch port and an outgoing TSI switch port for the link interface or processing engine.

In one implementation, TSI switch 108 performs time division multiplexing. TSI switch 108 is capable of switching a time slot in any incoming set of time slots to any time slot in any outgoing set of time slots. Any time slot from a link interface can be delivered to any processing engine. Any time slot from a processing engine can be delivered to any link interface that supports the protocol for the time slot's data. This provides a great deal of flexibility when switching data between link interfaces and processing engines—allowing data to be switched so that no processing engine or link interface becomes over utilized while others remain under utilized.

In an alternate embodiment, switch 108 is a packet switch. In this embodiment, the link interfaces and processing engines deliver data to packet switch 108 in the form of packets with headers. Packet switch 108 uses the headers to switch the packets to the appropriate link interface or processing engine.

FIG. 2A is a flowchart depicting one embodiment of a process for the ingress flow of data through network switch 90 when switch 108 is a TSI switch. An ingress link interface, such as link interface 100, 102, 104, or 106, receives physical signals over a medium, such as link 122 (step 10). The physical signals conform to a physical signaling standard from Layer 1 of the OSI model. In one implementation, each link interface includes one or more transceivers to receive the physical signals on the medium in accordance with the Layer 1 protocol governing the physical signaling. Different link interfaces in network switch 90 can support different Layer 1 physical signaling standards. For example, some link interfaces may support OC-48 physical signaling, while other link interfaces support physical signaling for Gigabit Ethernet. The reception process (step 10) includes the Layer 1 processing necessary to receive the data on the link.

In one implementation, each link supported by a link interface includes one or more channels. In one example, link 122 is an OC-48 link carrying 4 separate STS-12 channels. In different embodiments, a link can have various channel configurations. A link can also carry only a single channel of data. For example, link 122 can be an OC-48 link with a single STS-48 channel.

The ingress link interface maps data from incoming link channels into virtual channel time slots in switch 90 (step 12). As described above, one embodiment of switch 90 employs TSI switch 108 to pass data from ingress link interfaces to ingress processing engines. Each ingress link interface maps data from link channels to time slots that are presented to TSI switch 108 for switching. In one embodiment, each link interface maps link channel data into a set of 48 time slots for delivery to TSI switch 108.

Switch 90 employs virtual concatenation of time slots to form virtual channels within switch 90. Each time slot is assigned to a virtual channel. In some instances, multiple time slots are assigned to the same virtual channel to create a single virtual channel with increased bandwidth. In one example, each time slot has the ability to support bandwidth for a STS-1 channel of data. When a single time slot is assigned to a virtual channel, the virtual channel is an STS-1 channel. When multiple time slots are assigned to the same virtual channel, the resulting virtual channel operates as a single channel with the bandwidth of a single STS-X channel—X is the number of time slots assigned to the virtual channel. When multiple time slots are assigned to a single virtual channel there is no requirement for the assigned time slots to be adjacent to one another. However, the time slots can be adjacent in some embodiments. In further embodiments, time slots can support a channel bandwidth other than a STS-1 channel.

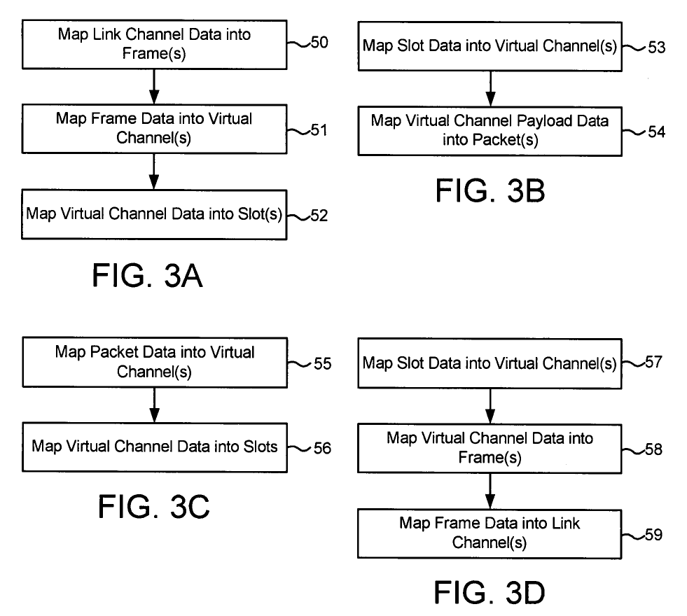

In various embodiments, different techniques can be employed for mapping link channel data into virtual channel time slots. In one example, a link includes 4 STS-12 channels, and the ingress link interface coupled to the link supports 4 STS-12 virtual channels—4 virtual channels each being assigned 12 time slots with STS-1 bandwidth. In this example, the ingress link interface maps data from each STS-12 link channel to a respective one of the 4 STS-12 virtual channels. FIG. 3A shows a process that employs Layer 2 framing before mapping link channel data into virtual channel time slots. More details regarding FIG. 3A are provided below.

The ingress link interface forwards the set of time slots to TSI switch 108 (step 14). In one implementation, each ingress link interface supports a set of 48 time slots, and TSI switch 108 receives a set of 48 time slots from each ingress link interface. In this embodiment, each ingress link interface forwards the set of 48 time slots to TSI switch 108 in the form of GFP framed data over SONET. In alternate embodiments, switch 90 employs different numbers of time slots and different methods of forwarding time slots to TSI switch 108.

TSI switch 108 switches the incoming time slots from ingress link interfaces to outgoing time slots for delivery to ingress processing engines (step 16). TSI switch 108 forwards sets of outgoing time slots to their respective ingress processing engines (step 18). There is an outgoing set of time slots associated with each ingress processing engine coupled to TSI switch 108. TSI switch 108 maps each incoming time slot from an ingress link interface to a time slot in an outgoing set of time slots for an ingress processing engine. TSI switch 108 has the ability to direct any incoming time slot of data from a link interface to any processing engine on any time slot in any outgoing set of time slots.

TSI switch 108 can map time slot data from an incoming set of time slots to time slots in multiple outgoing sets of time slots—a first time slot in an incoming set of time slots can be mapped to a time slot in one outgoing set of time slots and a second time slot in the incoming set of time slots can be mapped to a time slot in a different outgoing set of time slots. TSI switch 108 can also map time slots from different incoming sets of time slots to time slots in the same outgoing set of time slots—a time slot in a first incoming set of time slots can be mapped to a time slot in an outgoing set of time slots and a time slot in a different incoming set of time slots can be mapped to a time slot in the same outgoing set of time slots.

In one implementation, each ingress processing engine is assigned 48 outgoing time slots. TSI switch 108 maps the data from each incoming time slot to one of the 48 time slots for one of the ingress processing engines. TSI switch 108 forwards each outgoing set of 48 time slots to a respective ingress processing engine in the form of GFP framed data over SONET. In alternate implementations, an outgoing set of time slots can have a different format than the incoming set of time slots. More details regarding the mapping performed by TSI switch 108 appears below.

An ingress processing engine, such as processing engines 110, 112, 114, or 116, receives an outgoing set of time slots from TSI switch 108 and extracts payload data packets (step 20). The payload data is the data carried within each virtual channel. An ingress processing engine extracts the payload data and maps the data into packets that can be processed according to the protocols supported on the processing engine. In one implementation, one or more processing engines each support multiple protocols within each layer of the OSI model. In another implementation, one or more processing engines each support all protocols supported by the processing engines in switch 90 within each layer of the OSI model supported on the processing engines. These implementations allow an ingress processing engine to perform different processing on data from each of the virtual channels received via the outgoing set of time slots from TSI switch 108. In yet another embodiment, a processing engine does not support multiple protocols within each layer of the OSI model. Further details regarding the extraction of payload data are provided below with reference to FIG. 3B.

The ingress processing engine processes the extracted payload data packets according to the identified protocol for the data (step 22). Payload data received from one time slot may require different processing than payload data received from a different time slot. In one embodiment, the ingress processing engine performs data processing at Layer 2 and Layer 3 of the OSI model. In further embodiments, the ingress processing engine may perform processing at Layer 2, Layer 3 and above in the OSI model.

The ingress processing engine generates fabric cells for delivering processed data to an egress processing engine through fabric 120 (step 24). In one implementation, the ingress processing engine generates fabric cells by breaking the payload data associated with processing packets into smaller cells that can be forwarded to fabric 120. Various fabric cell formats can be employed in different embodiments. The ingress processing engine formats the cells according to a standard employed for delivering cells to fabric 120. Those skilled in the art will recognize that many different well-known techniques exist for formatting fabric cells. The ingress processing engine forwards the fabric cells to fabric 120 (step 26).

FIG. 2B is flowchart depicting one embodiment of a process for the egress flow of data through network switch 90 when switch 108 is a TSI switch. Fabric 120 forwards fabric cells to an egress processing engine, such as processing engine 110 and 112, 114, or 116 (step 30). The egress processing engine reassembles the fabric cells into one or more processing packets of data (step 32). The egress processing engine processes the packets according to the appropriate OSI model protocols. In one implementation, the egress processing engine performs Layer 2 and Layer 3 processing. In alternate implementations, there is no need for packet processing on the egress processing engine.

The egress processing engine maps processing packet data into virtual channel slots (step 36) and forwards the virtual channel slots to TSI switch 108 (step 38). On each egress processing engine, each virtual channel is represented by one or more time slots in a set of time slots. In one embodiment, each time slot can support the bandwidth of a STS-1 channel. In one implementation, the set of time slots includes 48 time slots, and the egress processing engine forward the 48 time slots to TSI switch 108 in the form of GFP framed data over SONET. In alternate embodiments, different time slot sizes can be employed and different mechanisms can be employed for forwarding sets of time slots. More details regarding the mapping of packet data into virtual channel slots is provided below with reference to FIG. 3C.

TSI switch 108 switches the incoming set of time slots from each egress processing engine (step 40). TSI switch 108 maps each time slot in an incoming set of time slots into a time slot in an outgoing set of time slots for delivery to an egress link interface. This mapping process is the same as described above for mapping data from ingress link interface time slots into outgoing sets of time slots for ingress processing engines (step 16, FIG. 2A). TSI switch 108 is capable of mapping any time slot from an egress processing engine set of time slots to any time slot of any outgoing set of time slots for any egress link interface. TSI switch 108 forwards outgoing sets of time slots to the appropriate egress link interfaces (step 42). In one implementation, an outgoing set of slots is in the form of GFP framed data over SONET. Different forwarding formats and time slot sizes can be employed in various embodiments.

An egress link interface that receives an outgoing set of time slots from TSI switch 108 maps virtual channel slot data into link channels (step 44). FIG. 3D shows a flowchart for one method of carrying out step 44 by framing virtual channel data and mapping the framed data into link channels. In alternate embodiments, different techniques can be employed to carryout step 44. The egress link interface transmits the physical signals for data in each link channel as physical signals on the medium coupled to the link interface (step 46). The link interface transmits the frames according to the Layer 1 signaling protocol supported on the medium.

FIG. 3A is a flowchart describing one embodiment of a process for mapping link channel data into virtual channel slots (step 12, FIG. 2A). The ingress link interface maps link channel data into frames (step 50). In one implementation, the ingress link interface performs Layer 2 processing on incoming link data to create Layer 2 frames. In alternate embodiments, different protocol rules can be employed to generate frames from link channel data. In one embodiment, switch 90 maintains mapping tables that are used by ingress processing engines to map link channel data into frames.

One implementation of the table contains entries with the following fields: 1) Link Channel—identifying a link channel for the ingress processing engine; 2) Protocol—identifying a Layer 1 and Layer 2 protocol for the identified link channel; and 3) Frame—identifying one or more frames to receive data from the identified link channel. When data arrives at an ingress link interface, the link interface uses the table entry that corresponds to the link channel supplying the data. The ingress link interface maps the data into the identified frames using the identified Layer 1 and Layer 2 protocols. Each link channel can be programmed for a different Layer 1 and/or Layer 2 protocol. A user of switch 90 programs the fields in the above-identified table in one embodiment. In further embodiments, different fields can be employed and mechanisms other than a mapping table can be employed.

The ingress processing engine maps the frame data into virtual channels (step 51) and maps the virtual channel's data into time slots in a set of time slots the link interface will forward to TSI switch 108 (step 52). In one implementation, these steps are performed as separate operations. In alternate implementations, these steps are combined into a single step.

In one embodiment, network switch 90 maintains mapping tables that are used by the ingress link interface to map incoming data into virtual channels and virtual channel data into a set of time slots. In one implementation, the table contains entries with the following fields: 1) Virtual Channel—identifying a virtual channel; 2) Time Slots—identifying all time slots in the ingress link interface's set of time slots that belong to the identified virtual channel; 3) Link Channel—identifying one or more link channels that are to have their data mapped into the identified virtual channel; and 4) Link Channel Protocol—identifying the Layer 1 and Layer 2 protocols employed for the data in the identified link channels. In one implementation, the Link Channel field can identify one or more frames formed as a result of step 50. Alternatively, different information can be used to identify link channel data for a virtual channel when the ingress link interface does not frame link channel data. A user of switch 90 programs these fields in one embodiment. In further embodiments, different fields can be employed and mechanisms other than a mapping table can be employed.

The ingress link interface uses a table entry to map data into a virtual channel. The ingress link interface maps data from the entry's identified link channel into the entry's identified time slots for the virtual channel. The ingress link interface formats the link channel data in the virtual channel time slots, based on the entry's identified Layer 1 and Layer 2 protocols for the link channel data.

FIG. 3B is a flowchart describing one embodiment of a process for extracting payload packets (step 20, FIG. 2A). The egress processing engine maps data from each time slot received from TSI switch 108 into a virtual channel (step 53) and maps data from the virtual channel into one or more payload data packets for processing (step 54). In one implementation, these steps are performed as separate operations. In alternate implementations, these steps are combined into a single step.

In one embodiment, network switch 90 maintains mapping tables that are used by the ingress processing engine to map incoming slot data to packets for processing by the ingress processing engine. In one implementation, the table contains an entry for each virtual channel. Each entry includes the following fields: 1) Virtual Channel—identifying a virtual channel; 2) Time Slots—identifying all time slots in the ingress processing engine's set of time slots that belong to the identified virtual channel; 3) Link Channel—identifying one or more link channels that are to have their data mapped into the identified virtual channel; and 4) Link Channel Protocol—identifying the Layer 1 and Layer 2 protocols employed for the data in the identified link channels. A user of switch 90 programs these fields in one embodiment. In further embodiments, different fields can be employed and mechanisms other than a mapping table can be employed.

The ingress processing engine uses this table to extract payload data into packets for processing. When each time slot of data arrives at the ingress processing engine, the ingress processing engine associates the time slot with a virtual channel in an entry corresponding to the time slot. The ingress processing engine parses the contents of the virtual channel to obtain payload data for processing packets. The ingress processing engine uses the information in the Link Channel Protocol field to parse the virtual channel. The ingress processing engine also places information in a header of each processing packet that identifies the link channel associated with the virtual channel being mapped into the packet. This information will be useful when directing the processing packet's contents through the egress flow described above.

FIG. 3C is a flowchart depicting one embodiment of a process for mapping packet data into virtual channel slots (step 36, FIG. 2B). The egress processing engine maps processing packet data into virtual channels (step 55) and maps virtual channel data into time slots (step 56) for delivery to TSI switch 108. In one implementation, these steps are performed as separate operations. In alternate implementations, these steps are combined into a single step.

In one embodiment, network switch 90 maintains mapping tables that are used by the egress processing engine to map packet data into virtual channel time slots. In one implementation, the table contains an entry for each virtual channel. Each entry includes the following fields: 1) Virtual Channel—identifying a virtual channel; 2) Time Slots—identifying all time slots in the egress processing engine's set of time slots that belong to the identified virtual channel; 3) Link Channel—identifying one or more link channels that are to have their data mapped into the identified virtual channel; and 4) Link Channel Protocol—identifying the Layer 1 and Layer 2 protocols employed for the data in the identified link channels. A user of switch 90 programs these fields in one embodiment. In further embodiments, different fields can be employed and mechanisms other than a mapping table can be employed.

The egress processing engine identifies the link channel that is intended to receive a processing packet's data. In one implementation, the processing packet's header includes this information. The egress processing engine identifies the table entry that corresponds to the link channel. The egress processing engine uses the entry to identify the corresponding virtual channel and associated time slots. The egress processing engine maps the packet data into these virtual channel time slots, based on the protocols identified in the Link Channel Protocol field.

FIG. 3D is a flowchart depicting one embodiment of a process for mapping virtual channel slot data into link channels (FIG. 44, FIG. 2B). The egress link interface maps time slot data from TSI switch 108 into virtual channels (step 57) and maps virtual channel data into frames (step 58). In one implementation, these steps are performed as separate operations. In alternate implementations, these steps are combined into a single step.

In one embodiment, network switch 90 maintains mapping tables that are used by the ingress link interface to map slot data into virtual channels and virtual channel data into frames. In one implementation, the table contains an entry for each virtual channel. Each entry includes the following fields: 1) Virtual Channel—identifying a virtual channel; 2) Time Slots—identifying all time slots in the egress link interface's set of time slots that belong to the identified virtual channel; 3) Link Channel—identifying one or more link channels that are to have their data mapped into the identified virtual channel; and 4) Link Channel Protocol—identifying the Layer 1 and Layer 2 protocols employed for the data in the identified link channels. A user of switch 90 programs these fields in one embodiment. In further embodiments, different fields can be employed and mechanisms other than a mapping table can be employed.

The egress link interface uses this table to map time slot data into virtual channels. For a time slot that arrives from TSI switch 108, the egress link interface maps data into the identified virtual channel for the time slot. For each virtual channel, the egress link interface maps the channel's data into the link interface identified for the virtual channel. For the framed data embodiment described above, the egress link interface maps the virtual channel data into one or more frames that correspond to the identified link channel. These frames can be identified as part of the Link Channel field in one embodiment. The egress link interface formats the virtual channel data in the frames, based on the identified Layer 1 and Layer 2 protocols for the link channel data.

In the frame data implementation, the egress link interface maps frame data into link channels (step 59). In one embodiment, switch 90 maintains mapping tables used by egress processing engines to map frame data into link channels. One implementation of the table contains entries for each link channel, including the following fields: 1) Link Channel—identifying a link channel for the egress processing engine; 2) Protocol—identifying Layer 1 and Layer 2 protocols for the identified link channel; and 3) Frame—identifying one or more frames that maintain data from the identified link channel. When virtual channel data is framed, the egress link interface uses the table entry that corresponds to a selected frame. The egress link interface maps the frame data into the identified channel using the identified Layer 1 and Layer 2 protocols. A user of switch 90 programs the fields in the above-identified table in one embodiment. In further embodiments, different fields can be employed and mechanisms other than a mapping table can be employed.

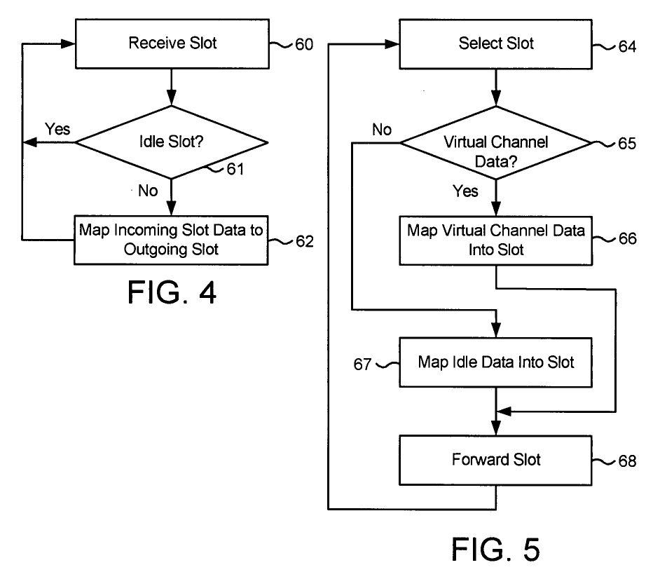

FIG. 4 is a flowchart depicting one embodiment of a process for TSI switch 108 to map slot data into outgoing slots. Ingress link interfaces and egress processing engines forward sets of time slots to TSI switch 108. In one implementation, slots are sent to TSI switch 108 in the form of GFP framed data over SONET. In one embodiment, TSI switch 108 receives a set of 48 time slots from each ingress link interface and egress processing engine.

TSI switch 108 receives an incoming time slot (step 60). TSI switch 108 determines whether the slot has idle data (step 61). If the slot is idle, TSI switch 108 loops back to step 60 to receive the next slot. If the slot is not idle, TSI switch 108 maps the data in the slot to a slot in an outgoing set of slots (step 62). TSI switch 108 maps data from an ingress link interface to a slot in an outgoing set of slots for an ingress processing engine. TSI switch 108 maps data from an egress processing engine to a slot in an outgoing set of slots for an egress link interface. TSI switch 108 returns to step 60 to receive the next incoming slot.

In one embodiment, TSI switch 108 employs a mapping table to map incoming slot data to a slot in an outgoing set of slots (step 62). One example of a mapping table includes entries with the following fields: 1) Incoming Port—identifying an incoming TSI switch port on TSI switch 108 that is coupled to either an ingress link interface or egress processing engine to receive a set of time slots; 2) Incoming Slot—identifying a time slot in the incoming set of time of slots on the identified incoming TSI switch port; 3) Outgoing Port—identifying an outgoing TSI switch port on TSI switch 108 that is coupled to either an ingress processing engine or egress link interface to provide an outgoing set of slots; and 4) Outgoing Slot—identifying a time slot in the outgoing set of slots for the identified outgoing TSI switch port.

When time slot data is received, TSI switch 108 finds a corresponding table entry. The corresponding table entry has an Incoming Port field and Incoming Slot field that correspond to the port on which the incoming set of slots is being received and the slot in the incoming set of slots that is being received. TSI switch 108 maps the incoming slot data to a slot in an outgoing set of slots that is identified by the entry's Outgoing Port and Outgoing Slot fields. In one implementation, each outgoing set of slots corresponds to an outgoing TSI switch port in TSI switch 108. The outgoing TSI switch port is coupled to deliver the outgoing set of slots to either an egress link interface or ingress processing engine.

In alternate embodiments, different mapping table formats can be employed. For example, each incoming TSI switch port in the TSI switch has its own mapping table in one embodiment—including the Incoming Slot, Outgoing Port, and Outgoing Slot fields. Alternatively, the Outgoing Port field can be modified to identify a transmit port that corresponds to a set of slots. In different embodiments, the mapping table is replaced by a different instrumentality that serves the same purpose.

In a further implementation, the above-described mapping table includes the following additional fields: 5) Backup Outgoing Port—identifying a backup outgoing TSI switch port for the port identified in the Outgoing Port field; 6) Backup Outgoing Slot—identifying a slot in the outgoing set of slots for the port identified in the Backup Outgoing Port field; and 7) Backup—indicating whether to use the Outgoing Port and Outgoing Slot fields or the Backup Outgoing Port and Backup Outgoing Slot fields. A user of switch 90 sets values in these fields in one implementation. In an alternate embodiment, these backup fields are maintained in a central memory of switch 90 and backup values are loaded into the above-described table only when a backup is needed.

These additional table fields can be used to support redundancy. A link interface or processing engine associated with an outgoing set of slots may become disabled. When this happens, TSI switch 108 will use the Backup Outgoing Port and Backup Outgoing Slot fields in place of the Outgoing Port and Outgoing Slot fields. This provides great flexibility in creating redundancy schemes on a per channel basis, per time slot basis, per port basis, per group of ports basis, or other basis. If a link interface fails, the virtual channel slots associated with the failed link interface can be redistributed among multiple link interfaces. Similarly, if a processing engine fails, the virtual channel slots associated with the failed processing engine can be redistributed among multiple processing engines. Switch 90 implements the redistribution by modifying the mapping information in the mapping table—switch 90 sets values in the above-described Backup fields to control the mapping operation of switch 108. This flexibility allows redundancy to be shared among multiple link interfaces and processing engines. In fact, network switch 90 can avoid the traditional need of having an entire link interface PCB and an entire processing engine PCB set aside for redundancy purposes. Switch 90 can modify mapping information automatically, upon detecting a condition that calls for modification. Alternatively, a user can manually alter mapping information.

Efficiency is greatly increased when each processing engine supports all protocols used in switch 90 at the OSI model layers supported by the processing engines. In this embodiment, each processing engine can receive and process data from any time slot in any link interface's set of time slots. This allows backup processing engines to be assigned so that no processing engine becomes over utilized and no processing engine remains under utilized. In one implementation, switch 90 modifies mapping information by setting values in the Backup fields to facilitate efficient bandwidth pooling. Switch 90 monitors the utilization of processing engines and link interfaces. If any link interface or processing engine becomes over or under utilized, switch 90 sets values in the above-described Backup fields to redirect the flow of data to make link interface and processing engine utilization more evenly distributed.

In a further embodiment, switch 90 employs the above-described Backup field to implement 1:N, 1:1, or 1+1 redundancy. In 1:N redundancy, a time slot or set of time slots is reserved for backing up a set of N time slots. In 1:1 redundancy, each time slot or set of time slots is uniquely backed up by another time slot or set of time slots. In 1+1 redundancy, an incoming time slot is mapped to two outgoing time slots—one time slot identified by the Outgoing Port and Outgoing Slot fields, and another time slot identified by the Backup Outgoing Port and Backup Outgoing Slot fields. This allows redundant dual paths to be created through switch 90. The ability of switch 90 to efficiently distribute processing engine resources allows this dual path redundancy to be achieved without significant decrease in the overall throughput performance of switch 90.

FIG. 5 is a flowchart depicting one embodiment of a process for TSI switch 108 to forward slots in an outgoing set of slots. TSI switch 108 selects a slot (step 64). TSI switch 108 determines whether the slot is to contain an idle signal or valid virtual channel slot data (step 65). If the slot is to be idle, TSI switch 108 maps an idle data pattern into the selected slot (step 67) and forwards the slot to an ingress processing engine or egress link interface (step 68). If the slot is not idle (step 65), TSI switch 108 maps virtual channel data into the selected slot (step 66) and forwards the slot to an ingress processing engine or egress link interface (step 68). TSI switch 108 continues to loop back to step 64 and repeat the above-described process.

In one implementation, the process in FIG. 5 can be performed in real time while the outgoing set of slots is being forwarded. Alternatively, an entire outgoing set of slots is assembled before forwarding any channels.

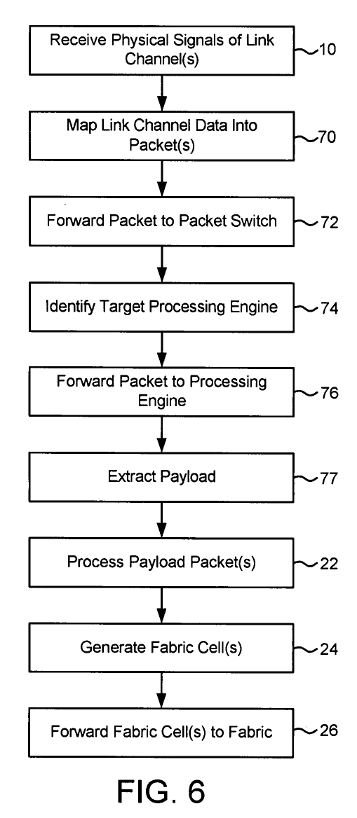

FIG. 6 is a flowchart depicting an alternate embodiment of a process for the ingress flow of data through network switch 90 when switch 108 is a packet switch. The process steps with the same numbers as those appearing in FIG. 2A operate the same as described for FIG. 2A. The description in FIG. 6 will highlight the differences in the ingress data flow when packet switch 108 is employed.

After the ingress link interface receives physical signals for link channels (step 10), the ingress processing engine maps link channel data into one or more packets (step 70). The link interface forwards each packet to packet switch 108 (step 72) for delivery to an ingress processing engine. Each packet includes a payload and a header. The payload includes the data received from the physical medium that needs to be forwarded to an ingress processing engine. The header includes information necessary for packet switch 108 to properly direct the packet to a targeted ingress processing engine. The ingress link interface creates the header in the step of mapping data into the packet (step 70).

In one implementation, the header includes the following fields: 1) Destination PE—identifying the targeted ingress processing engine; 2) Source LI—identifying the ingress link interface that created the packet; 3) Source PHY—identifying the link interface transceiver that received the data in the packet's payload; and (4) Source Channel—identifying a link channel in which the payload data was received by the ingress link interface. In alternate embodiments, different header fields can be employed.

In one implementation, the ingress link interface maps data into the packet's payload (step 70) using a mapping table. One embodiment of the mapping table includes entries with the following fields: 1) Destination—identifying a processing engine; 2) Link Channel—identifying a link channel; and 3) Protocol—identifying the Layer 1 and Layer 2 protocols format of data in the identified link channel. A user of switch 90 programs these fields in one embodiment. The ingress link interface maps data into a packet from a link channel. The ingress link interface identifies a table entry that corresponds to the link channel and uses the protocols specified in the entry's Protocol field to move data from the link channel to the packet. The ingress link interface also loads the Destination PE field in the packet header with the processing engine identified in the entry's Destination field.

Packet switch 108 identifies the targeted ingress processing engine for the packet (step 74) and forwards the packet to the targeted ingress processing engine (step 76). In one implementation, packet switch 108 uses the Destination PE field in the packet header to identify the targeted ingress processing engine. The ingress processing engine extracts payload data in the packets from packet switch 108 (step 77). The ingress processing engine maps the payload data into processing packets for processing by the ingress processing engine.

In one embodiment, network switch 90 maintains mapping tables that are used by the ingress processing engine to map payload data from the ingress processing engine into processing packets (step 77). In one implementation, the table contains entries with the following fields: 1) Source Information—identifying a permutation of values from the packet header fields Source LI, Source PHY, and Source Channel; 2) Protocol—identifying the Layer 1 and Layer 2 protocols associated with the data having a header that matches the Source Information field; and 3) Link Channel—identifying the link channel that originated the data. A user of switch 90 programs these fields in one embodiment. In alternate embodiments, different fields can be employed, or other instrumentalities can replace the table.

When a packet arrives from packet switch 108, the ingress processing engine finds an entry with a Source Information field that corresponds to the values in the packet's header. The ingress processing engine then uses the identified entry's Protocol field to map the packet payload data into a processing packet. In one implementation, the ingress processing engine also includes a link channel identifier in the processing packet, based on the Link Channel field. The remaining steps in FIG. 6 conform to those described above for FIG. 2.

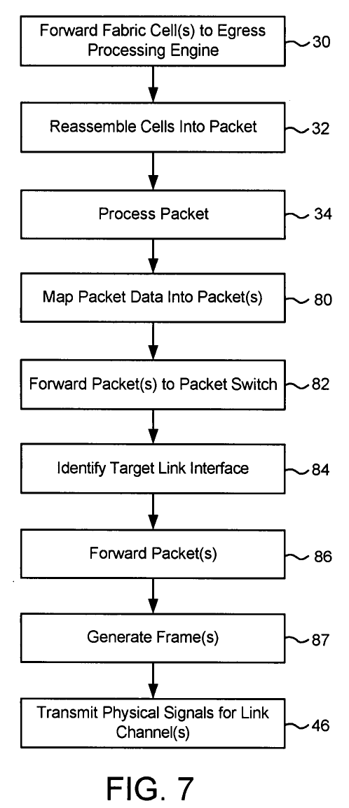

FIG. 7 is a flowchart depicting an alternate embodiment of a process for the egress flow of data through network switch 90 when switch 108 is a packet switch. The steps in FIG. 7 with the same reference numbers as those in FIG. 3 operate in the same manner described for FIG. 3. The description of FIG. 7 will highlight the differences in the egress data flow when switch 108 is a packet switch.

After processing packets from reassembled fabric cells (Step 34), the egress processing engine maps packet data into new packets for delivery to packet switch 108 (step 80). In one implementation, the egress processing engine uses a mapping table to perform this operation. One embodiment of the mapping table includes the following fields: 1) Packet Information—identifying information to use in a packet header; 2) Link Channel—identifying a link channel that originated the data being put into the packet; and 3) Protocol—identifying the Layer 1 and Layer 2 protocols for the packet data. A user of network switch 90 configures these fields. In alternate embodiments, different fields can be employed, or the table can be replaced by a different instrumentality.

The egress processing engine identifies a table entry that has a Link Channel field that corresponds to the link channel that originated the payload data in the processing packet. The egress processing engine maps the payload data into a packet for packet switch 108, based on the protocols in the corresponding Protocol field. The egress processing engine uses the entry's Packet Information field to create a header for the packet. In one implementation, the packet headers include the following fields: 1) Source PE—identifying the egress processing engine that created the packet; 2) Destination LI—identifying a targeted egress link interface for the packet 3) Destination PHY—identifying a targeted transceiver on the identified egress link interface; and (4) Destination Channel—identifying a targeted link channel in which the payload data is to be transmitted from the egress link interface. In alternate embodiments, different header fields can be employed.

The egress processing engine forwards the new packets to packet switch 108 for switching to the targeted egress link interface (step 82). Packet switch 108 identifies the targeted egress link interface for the incoming packet (step 84). Packet switch 108 uses the header information in the packet to make this identification. For the header described above, the Destination LI field identifies the targeted egress link interface. Packet switch 108 forwards the packet to the targeted egress link interface (step 86). Transmission data frames are generated (step 87) and physically transmitted (step 46). In order to generate frames (step 87), the egress processing engine uses the header fields in the packet from packet switch 108. In one implementation, packet switch 108 uses the Destination PHY and Destination Channel fields to generate these frames.

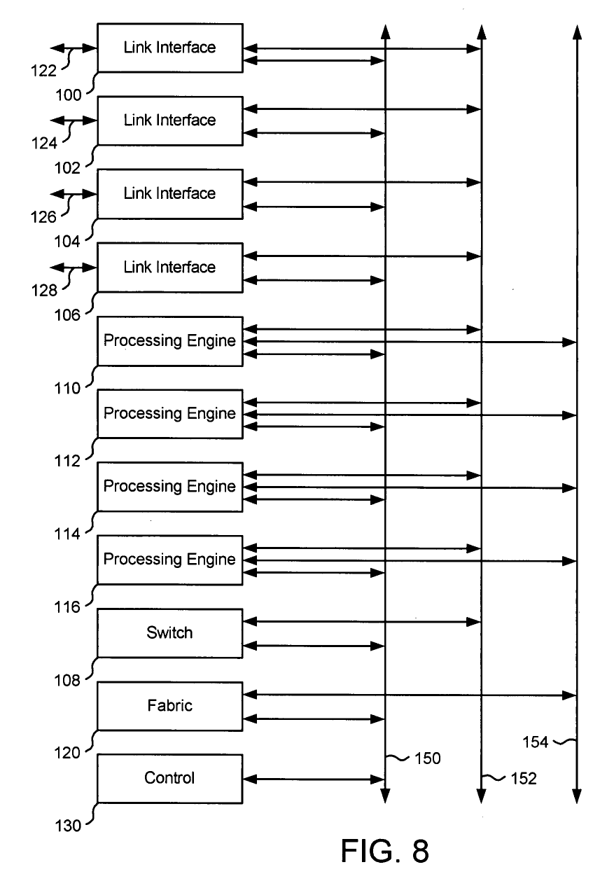

FIG. 8 is a block diagram depicting one embodiment of switch 90, implemented with a mid-plane architecture. Switch 90 includes control module 130, which is coupled to control bus 150. The above-described link interfaces 100, 102, 104, and 106, processing engines, 110, 112, 114, and 116, switch 108, and fabric 120 are also coupled to control bus 150. Control bus 150 carries control information for directing the operation of components in switch 90. In one implementation, control bus 150 is a 100 Base-T Ethernet communication link. In such an embodiment, control bus 150 employs the 100 Base-T Ethernet protocols for carrying and formatting data. In alternate embodiments, a variety of different protocols can be employed for implementing control bus 150. In a further embodiment, control bus 150 is a star-like switched Ethernet network. Further details regarding the operation of control module 130 are provided below.

Link interfaces 100, 102, 104, and 106, processing engines 110, 112, 114, and 116, and switch 108 are coupled to switch plane 152. Switch plane 152 carries sets of time slots. In one implementation, switch 108 is a TSI switch and switch plane 152 carries GFP framed data over SONET. In one such implementation, the capacity of switch plane 152 is 2.488 Giga-bits per second, with the SONET frame containing 48 time slots that each support bandwidth equivalent to one STS-1 channel. Alternatively, the frame may include higher bandwidth channels or even different size channels. In further embodiments, switch plane 152 carries STS-192 SONET. In another embodiment, switch 108 is a packet switch and switch plane 152 carries packets. Processing engines 110, 112, 114, and 116 and fabric 120 are coupled to fabric plane 154. The processing engines and fabric 120 exchange fabric cells across fabric plane 154.

FIG. 8 shows data planes 152 and 154 as separate from control bus 150. In alternate embodiments, control bus 150 can be implemented as part of switch plane 152 and fabric plane 154.

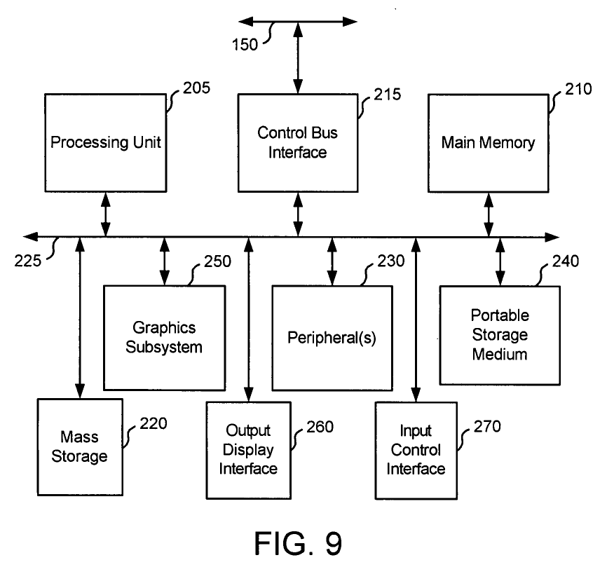

FIG. 9 is a high-level block diagram depicting one embodiment of control module 130. In one embodiment, control module 130 is a PCB in switch 90. Control module 130 directs the operation of link interfaces 100, 102, 104, and 106, processing engines 110, 112, 114, and 116, switch 108, and fabric 120. In one implementation, control module 130 directs the operation of these components by issuing configuration and operation instructions that dictate how the components operate.

Control module 130 also maintains a management information base (“MIB”) that maintains the status of each component at various levels of detail. In one implementation, the MIB maintains information for each link interface and each processing engine. This enables control module 130 to determine when a particular component in switch 90 is failing, being over utilized, or being under utilized. Control module 130 can react to these determinations by making adjustments in the internal switching of data between link interfaces and processing engines through switch 108—changing switching of data associated with failed or inefficiently utilized components.

In one example, control module 130 detects that a processing engine is under utilized. Control module 130 responds by arranging for switch 108 to switch one or more time slots from one or more link interfaces to the under utilized processing engine. In another example, control module 130 determines that a failure occurred at a link interface. Control module 130 arranges for switch 108 to switch each time slot originally directed to the failed link interface to one or more different link interface. In one implementation, the time slots are distributed to several alternative link interfaces. Control module 130 facilitates the above-described time slot switching changes by modifying mapping table information, such as the Backup field, in one embodiment. The mapping table information can be maintained in control module 130 or distributed on switch 108.

In one embodiment, control module 130 contains processing unit 205, main memory 210, and interconnect bus 225. Processing unit 205 may contain a single microprocessor or a plurality of microprocessors for configuring control module 130 as a multi-processor system. Processing unit 205 is employed in conjunction with a memory or other data storage medium containing application specific program code instructions to implement processes carried out by switch 90.

Main memory 210 stores, in part, instructions and data for execution by processing unit 205. If a process is wholly or partially implemented in software, main memory 210 can store the executable instructions for implementing the process. In one implementation, main memory 210 includes banks of dynamic random access memory (DRAM), as well as high-speed cache memory.

Control module 130 further includes control bus interface 215, mass storage device 220, peripheral device(s) 230, portable storage medium drive(s) 240, input control device interface 270, graphics subsystem 250, and output display interface 260, or a subset thereof in various embodiments. For purposes of simplicity, all components in control module 130 are shown in FIG. 9 as being connected via bus 225. Control module 130, however, may be connected through one or more data transport means in alternate implementations. For example, processing unit 205 and main memory 210 may be connected via a local microprocessor bus. Control bus interface 215, mass storage device 220, peripheral device(s) 230, portable storage medium drive(s) 240, and graphics subsystem 250 may be coupled to processing unit 205 and main memory 210 via one or more input/output busses.

Mass storage device 220 is a non-volatile storage device for storing data and instructions for use by processing unit 205. Mass storage device 220 can be implemented in a variety of ways, including a magnetic disk drive or an optical disk drive. In software embodiments, mass storage device 220 stores the instructions executed by control module 130 to perform processes in switch 90.

Portable storage medium drive 240 operates in conjunction with a portable non-volatile storage medium to input and output data and code to and from control module 130. Examples of such storage mediums include floppy disks, compact disc read only memories (CD-ROM) and integrated circuit non-volatile memory adapters (i.e. PC-MCIA adapter). In one embodiment, the instructions for control module 130 to execute processes in switch 90 are stored on such a portable medium, and are input to control module 130 via portable storage medium drive 240.

Peripheral device(s) 230 may include any type of computer support device, such as an input/output interface, to add additional functionality to control module 130. For example, peripheral device(s) 230 may include a communications controller, such as a network interface, for interfacing control module 130 to a communications network. Instructions for enabling control module 130 to perform processes in switch 90 may be downloaded into main memory 210 over a communications network. Control module 130 may also interface to a database management system over a communications network or other medium that is supported by peripheral device(s) 230.

Input control device interface 270 provides interfaces for a portion of the user interface for control module 130. Input control device interface 270 may include an alphanumeric keypad for inputting alphanumeric and other key information, a cursor control device, such as a mouse, a trackball, stylus, or cursor direction keys. In order to display textual and graphical information, control module 130 contains graphics subsystem 250 and output display interface 260. Output display interface 260 can include an interface to a cathode ray tube display or liquid crystal display. Graphics subsystem 250 receives textual and graphical information, and processes the information for output to output display interface 260.

Control bus interface 215 is coupled to bus 225 and control bus 150. Control bus interface 215 provides signal conversion and framing to support the exchange of data between bus 225 and control bus 150. In one implementation, control bus interface 215 implements 100 Base-T Ethernet protocols—converting data between the format requirements of bus 225 and the 100 Base-T Ethernet format on control bus 150.

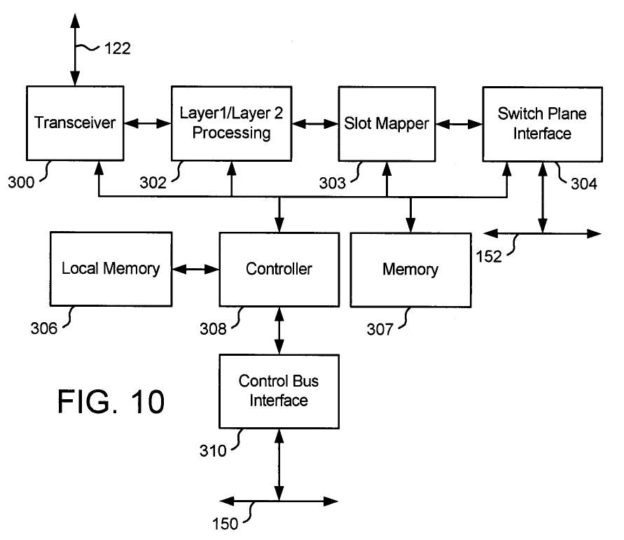

FIG. 10 is a block diagram of one embodiment of a link interface in switch 90, such as link interface 100, 102, 104, or 106. The link interface in FIG. 10 is for use when switch 108 is a TSI switch. In one implementation, the link interface shown in FIG. 10 is a PCB. FIG. 10 will be described with reference to link interface 100, but the implementation shown in FIG. 10 can be applicable to other link interface modules. In one implementation, each link interface resides in switch 90 as a PCB.

Link interface 100 includes transceiver 300 for receiving and transmitting data signals on medium 122 in accordance with the physical signaling requirements of medium 122. In one implementation, transceiver 300 is an optical transceiver. In another embodiment, transceiver 300 is a Giga-bit Ethernet transceiver for exchanging physical signals with medium 122 in accordance with the physical signaling standards of Giga-bit Ethernet.

Transceiver 300 is coupled to Layer 1/Layer 2 processing module 302. During ingress, transceiver 300 sends signals from medium 122 to processing module 302. In one implementation, processing module 302 carries out all Layer 1 processing for incoming data and a portion of required Layer 2 processing. In some implementations, processing module 302 does not perform any Layer 2 processing. Processing module 302 supports different protocols in various embodiments. During an egress operation, processing module 302 processes data according to Layer 1 and Layer 2 protocols to prepare the data for transmission onto medium 122.

Processing module 302 is coupled to slot mapper 303. During ingress, slot mapper 303 obtains data from processing module 302. Slot mapper 303 performs the above-described operations for mapping data into virtual channel time slots (steps 51 and 52, FIG. 3A) and forwarding time slot to TSI switch 108 (step 14, FIG. 2A). During egress, slot mapper 303 receives data from processing engines over switch plane 152. Slot mapper 303 maps slot data into virtual channels for use by processing module 302 in performing Layer 2 framing and Layer 1 processing.

Slot mapper 303 is coupled to switch plane interface 304. Switch plane interface 304 is coupled to switch plane 152 to transfer data between channel mapper 303 and plane 152. During data ingress, switch plane interface 304 forwards sets of time slots from slot mapper 303 onto switch plane 152. In one implementation, interface 304 sends sets of time slots over switch plane 152 in the form of GFP framed data over SONET. During egress, interface 304 transfers data from switch plane 152 to slot mapper 303.

Controller 308 directs the operation of transceiver 300, processing module 302, slot mapper 303, and switch plane 304. Controller 308 is coupled to these components to exchange information and control signals. Controller 308 is also coupled to local memory 306 for accessing data and software instructions that direct the operation of controller 308. Controller 308 is coupled to control bus interface 310, which facilitates the transfer of information between link interface 100 and control bus 150. Controller 308 can be implemented using any standard or proprietary microprocessor or other control engine. Controller 308 responds to instructions from control module 130 that are received via control bus 150. Memory 307 is coupled to controller 308, Layer 1/Layer 2 processing module 302, and slot mapper 303 for maintaining instructions and data.

Controller 308 performs several functions in one embodiment. Controller 308 collects network related statistics generated by transceiver 300 and Layer 1/Layer 2 processing module 302. Example statistics include carrier losses on medium 122 and overflows in Layer 1/Layer 2 processing module 302. Controller 308 and control module 130 employ these statistics to determine whether any failures have occurred on link interface 100. The collected statistics can also enable controller 308 and control module 130 to determine the level of bandwidth traffic currently passing through link interface 100. Control module 130 uses this information to ultimately decide how to distribute the bandwidth capacity of link interfaces and processing engines within switch 90. Controller 308 carries out instructions from control module 130 when implementing link interface and processing engine switchovers to account for failures or improved resource utilization. The instructions may call for activating or deactivating transceiver 300.

In one example, controller 308 identifies a failure in transceiver 300. Controller 308 stores this indication in a database in memory 307. The failure information stored in memory is provided to control module 130. Control module 130 uses this information to deactivate link interface 100 and initiate a switchover process—assigning one or more link interfaces in switch 90 to begin carrying out the operations of link interface 100.

In another example, controller 308 provides control module 130 with information relating to the amount of bandwidth being utilized on link 122—indicating whether link interface 100 can handle more traffic or needs assistance in handling the current traffic. Based on this information, control module 130 may decide to switchover some of the responsibilities of link interface 100 to one or more different link interfaces. If a switchover is needed, control module 120 arranges for the mapping table information to be modified, as described above for one embodiment.

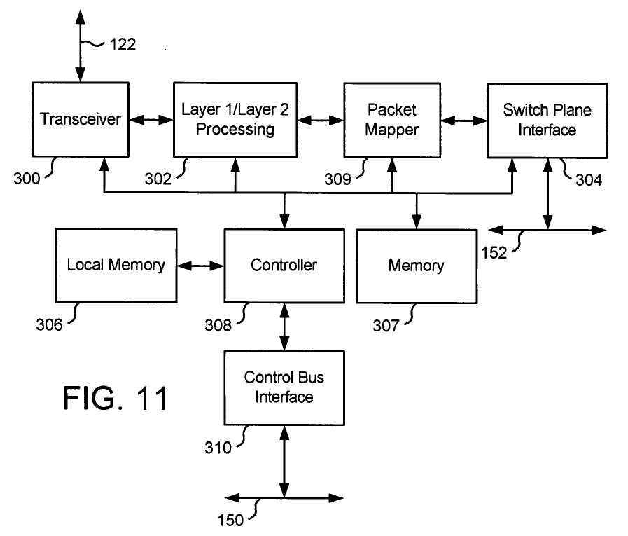

FIG. 11 is a block diagram depicting an alternate embodiment of a link interface when switch 108 is a packet switch. The components of FIG. 11 that are numbered the same as a component in FIG. 10 operate the same as described for FIG. 10. The only difference is that slot mapper 303 from FIG. 10 is replaced by packet mapper 309. Packet mapper 309 is coupled to exchange data with Layer 1\Layer 2 processing module 302 and switch plane interface 304.

During ingress, packet mapper 309 maps data into packets (step 70, FIG. 6). Packet mapper 309 retrieves data from processing module 302. Packet mapper 309 maps the data into packet payloads and places headers on the packets. Packet mapper 309 then forwards the packets to switch plane 304, which forwards the packets to packet switch 108.

During egress, packet mapper 309 assists in generating data frames for transmission (step 87, FIG. 7). Packet mapper 309 receives data from switch plane interface 304 in the form of packets formatted for packet switch 108. Packet mapper 309 places the data for the packets into a format that allows processing module 302 to properly direct the packet payloads into frames for transmission by transceiver 300.

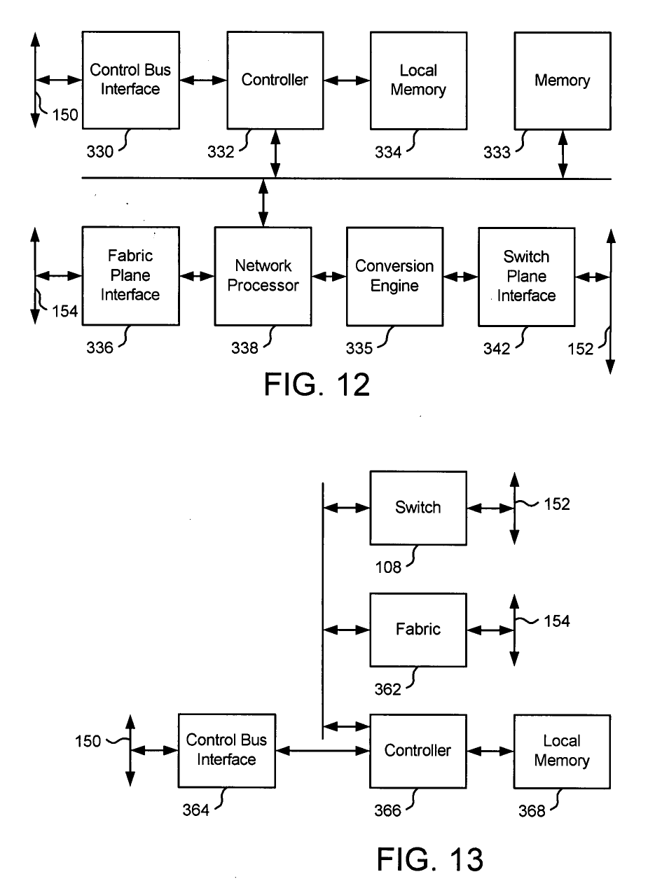

FIG. 12 is a block diagram depicting one embodiment of a processing engine in switch 90, such as processing engines 110, 112, 114, and 116. In one embodiment, processing engines 110, 112, 114, and 116 are each implemented as PCBs in switch 90. In one implementation, each processing engine in switch 90 support all of the protocols for each OSI model layer supported on the processing engine. This enables any processing engine to exchange data with any link interface in switch 90. This provides switch 90 with the freedom to allocate processing engine resources without considering the protocol employed in incoming data. The granularity of internal data switching between link interfaces and processing engines can vary in different embodiments. In one embodiment, switch 90 is able to individually switch a single time slot of data from each link interface to a processing engine.

Although FIG. 12 is described with respect to processing engine 110, the description applies to all processing engines in switch 90. Processing engine 110 includes network processor 338 coupled to exchange information with fabric plane interface 336 and switch plane interface 342 via conversion engine 335. Interface 342 is coupled to switch plane 152 to exchange data between processing engine 110 and switch 108. Interface 336 is coupled to fabric plane 154. Interface 336 uses plane 154 to exchange data between processing engine 110 and fabric 120.

During data ingress, interface 342 receives data provided on plane 152. Interface 342 provides the data to conversion engine 335. Conversion engine 335 extracts payloads (step 20, FIG. 2A) from received sets of time slots for processing (step 22, FIG. 2A) at Layer 2 and above. Conversion engine 335 maps an extracted payload into a desired packet format and forwards the packet to network processor 338 for processing.

Network processor 338 processes data from plane 152 according Layer 2 protocols and above. Network processor 338 also performs the above-described function of generating fabric cells (step 24, FIG. 2A). Fabric plane interface 336 receives fabric cells from network processor 338. Interface 336 transmits the fabric payload onto fabric plane 154 (step 26, FIG. 2A).

During data egress, network processor 338 processes data in fabric cells received from fabric plane 154 through fabric plane interface 336—reassembling cells into packets and processing the packets at Layer 2 and above (steps 32 and 34, FIG. 2B). Network processor 338 passes processed data to conversion engine 335. Conversion engine 335 maps the data into one or more virtual channel time slots (step 36, FIG. 2B). Conversion engine 335 passes egress sets of time slots to plane 152 via switch plane interface 342. Interface 342 places sets of time slots on plane 152, which carries the data to switch 108.

In an alternate embodiment, switch 108 is a packet switch. In this embodiment, conversion engine 335 converts data between processing packets and packets exchanged with packet switch 108 (step 77, FIG. 6 and step 80, FIG. 7).

Network processor 338 carries out operations that support the applications running on switch 90. For example, switch 90 may support virtual private networks by acting as a Provider Edge Router. Network processor 338 maintains routing tables for the virtual private networks. Processing engine 338 employs the tables to properly route data for a VPN to the next step in a virtual circuit in the VPN.

Processing engine 110 also includes controller 332, which is coupled to local memory 334 and control bus interface 330. Network processor 338 is coupled to controller 332 to receive data and control instructions. Controller 332 performs many of the same functions described above for controller 308 on link interface 100, except that controller 332 performs operations specific to the operation of processing engine 110. Local memory 334 holds instructions for controller 332 to execute, as well as data maintained by controller 332 when operating. Control bus interface 330 operates the same as the above-described control bus interface 310 in FIG. 10. Memory 333 is coupled to controller 332 and network processor 338 to maintain data and instructions.

One application performed on controller 332 is the maintenance of network related statistics. Network processor 338 collects statistics based on information in the data frames passing through processing engine 110. These statistics identify whether a failure has occurred on processing engine 110 or another component within switch 90. Additional statistics collected by network processor 338 indicate the level of utilization that processing engine 110 is experiencing. These statistics are made available to controller 332 for delivery to control module 130.

Example statistics include whether frames have been dropped and the number of frames passing through network processor 338. When a failure is detected, controller 332 signals control module 130 over bus 150. In one implementation, controller 332 performs this operation by sending data over bus 150 that contains information to indicate that a failure has taken place. Similarly controller 332 can send information over bus 150 to control module 130 that indicates the level of bandwidth utilization on processing engine 110. Alternatively, control module 130 can access raw statistics in local memory 334 and memory 333 and make failure and utilization assessments.

In response to the statistics provided by controller 332, control module 130 may decide that it is appropriate to perform a switchover that involves processing engine 110 or other components within switch 90. Control module 130 sends instructions to controller 332 over bus 150 to identify the actions for processing engine 110 to implement to facilitate a switchover. These actions may include activating or deactivating processing engine 110. In the case of processing engine 110 being substituted for another processing engine, control module 130 may provide controller 332 with information that brings processing engine 110 to the current state of the other processing engine. This allows processing engine 110 to operate in place of the replaced component.

Controller 332 can also support the performance of many other applications by network processor 338. In various embodiments, controller 332 can direct the operation of network processor 338 in performing tunneling, frame relay support, and Ethernet switching and bridging functions. These are only examples of some applications that can be performed on processing engine 110. A wide variety of applications can operate on processing engine 110.

FIG. 13 is a block diagram depicting one embodiment of a single line card module that contains both fabric 120 and switch 108. Switch 108 directs data between link interfaces and processing engines over switch plane 152. During ingress, data passes from an ingress link interface onto plane 152, into switch 108, back onto plane 152, and into one or more processing engines. During egress, switch 108 receives data from an egress processing engine on plane 152 and provides that data to one or more egress link interfaces via plane 152. Fabric 120 provides for the exchange of data between processing engines. Fabric 120 receives data on plane 154 from an ingress processing engine and passes the data to an egress processing engine on plane 154.

Switch 108 and fabric 120 are both coupled to controller 366. Controller 366 interfaces with local memory 368 and network control bus interface 364 in a manner similar to the one described above for controller 308 in link interface 100 (FIG. 10). Memory 368 maintains instructions for directing the operation of controller 366, as well as data employed by controller 366 in operation. Control bus interface 364 allows controller 366 to exchange data and control information with control module 130 over control bus 150. In one implementation, control bus interface 364 supports the transmission of 100 Base-T Ethernet information over control bus 150.

As with the controllers described above, controller 366 supports the performance of a number of applications by fabric 120 and switch 108. In one application, controller 366 collects statistical information from switch 108 and fabric 120. One type of statistical information identifies the amount of data passing through fabric 120 and switch 108. Other statistics indicate whether switch 108 or fabric 120 have failed. Those skilled in the art will recognize that various embodiments allow for controller 366 to collect a wide array of different statistical information. Controller 366 communicates the collected statistical information to control module 130 over bus 150. Control module 130 uses the statistical information to determine whether the responsibilities assigned to any link interface or processing engine need to be redistributed.

Controller 366 also supports the redistribution of responsibilities—enabling control module 130 to change switching rules in switch 108. For example, controller 366 can program the above-described Backup field values in TSI switch 108—redistributing time slot data among different link interfaces and processing engines.

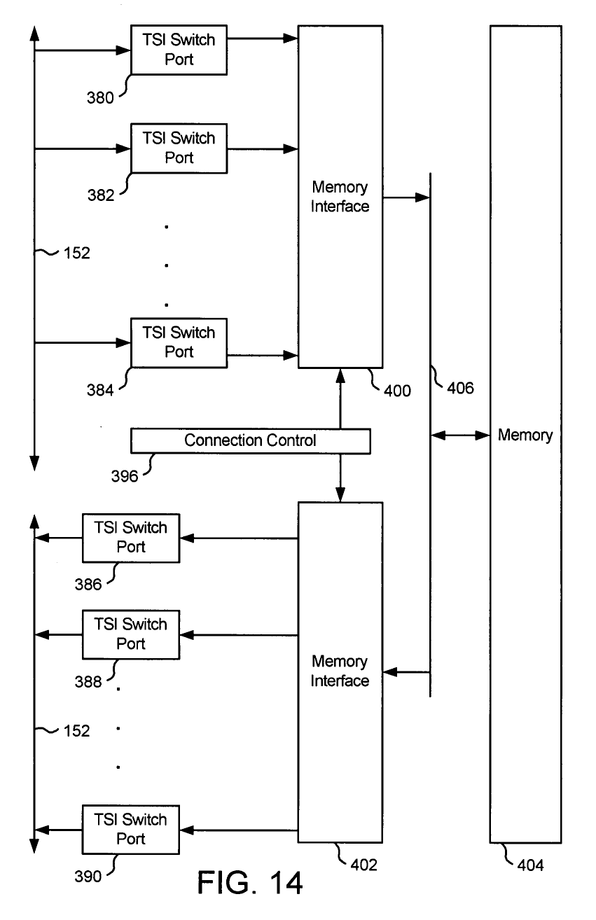

FIG. 14 is a block diagram depicting one embodiment of TSI switch 108. TSI switch 108 includes an incoming TSI switch port for each link interface and an incoming TSI switch port for each processing engine. Each incoming TSI switch port is coupled to either a link interface or processing engine. In one embodiment, TSI switch 108 includes 24 incoming TSI switch ports coupled to link interfaces and 12 incoming TSI switch ports coupled to processing engines. A subset of the incoming TSI switch ports in TSI switch 108 are shown in FIG. 14 as TSI switch ports 380, 382 and 384. Incoming TSI switch ports coupled to link interfaces receive ingress data in the form of a set of time slots, such as 48 time slots sent in the format of GFP framed data over a SONET. Incoming TSI switch ports coupled to processing engines receive egress data in the form of a set of time slots, such as 48 time slots sent in the format of GFP framed data over SONET.

The incoming TSI switch ports are used during the process steps described above with reference to FIG. 4 for receiving and mapping incoming time slot data to outgoing time slots. Each incoming TSI switch port is coupled to switch plane 152 to receive a set of time slots from either a link interface or processing engine. Each incoming TSI switch port is also coupled to memory interface 400. When an incoming TSI switch port receives a time slot of data (step 60, FIG. 4), TSI switch 108 maps the slot data to a time slot in an outgoing set of time slots (step 62, FIG. 4). TSI switch 108 maps the slot data by storing it into a location in memory 404 that is designated for the slot in the outgoing set of time slots.

Each incoming TSI switch port is coupled to memory interface 400, which is coupled to memory bus 406. Memory bus 406 is coupled to memory 404 to exchange data. In operation, data from a slot in an incoming TSI switch port is provided to memory interface 400 along with an identifier for a slot in an outgoing set of time slots. Memory interface 400 loads the data from the incoming TSI switch port's slot into a location in memory 404 that corresponds to the identified time slot in the outgoing set of time slots.

TSI switch 108 also includes connection control 396. Connection control 396 is coupled to memory interface 400 to provide mapping information. The information from connection control 396 informs memory interface 400 where to map each incoming time slot. In one implementation, connection control 396 includes the above-described mapping tables employed by TSI switch 108.

TSI switch 108 also includes a set of outgoing TSI switch ports. Each outgoing TSI switch port is coupled to either a link interface or a processing engine to forward outgoing sets of time slots. TSI switch 108 includes an outgoing TSI switch port for each link interface and an outgoing TSI switch port for each processing engine. The outgoing TSI switch ports are coupled to the link interfaces and processing engines over switch plane 152. Outgoing TSI switch ports coupled to processing engines deliver outgoing sets of time slots to the processing engine during ingress data flow. Outgoing TSI switch ports coupled to link interfaces provide outgoing sets of time slots to the link interfaces during egress data flow. FIG. 14 shows a subset of the outgoing TSI switch ports as transmit ports 386, 388 and 390.

The outgoing TSI switch ports are used in carrying out the forwarding of outgoing sets of time slots as shown above in FIG. 5. When an outgoing set of time slots needs to be transmitted, memory interface 402 retrieves the data for the time slots from locations in memory 404 that are designated to the slots (step 66, FIG. 5). Connection control 396 is coupled to memory interface 402 to indicate whether valid data exists in memory 404 for a time slot or idle data needs to be resident in the portion of the outgoing TSI switch port corresponding to the slot. When valid data exists, memory interface 402 retrieves the data from memory 404.

Each outgoing TSI switch port communicates with memory 404 through memory interface 402 over memory bus 406. Each outgoing TSI switch port is coupled to memory interface 402. Memory interface 402 is coupled to memory bus 406 to retrieve data from memory 404 to service channel data requests from transmit ports.

In alternate embodiments, different designs can be employed for TSI switch 108 that facilitate the above-described operation of TSI switch 108. In various embodiments, different TDM switches can be employed.

### Hybrid Switching System

A hybrid switching system that incorporates two types of system design, back-plane design and mid-plane design, is described.

In a system with the back-plane design, the physical interfaces (also referred to as the PHY) and the packet processor (also referred to as the forwarding engines or packet processing engine) are in a fixed configuration. The processing engine can be implemented using ASIC, NPU, FPGA, software, or a combination thereof. Packet processing engines are typically the most expensive component in the system. Packets received on a specific physical interface are forwarded to a corresponding packet processor to perform extensive processing functions such packet lookup, policy management, manipulation, scheduling and forwarding. The processed packets are transmitted over a packet switch fabric to another processing engine, where additional processing functions are performed before the packets are sent out on another PHY.

In a system that only implements the back-plane design, the processing engines are bundled with a fixed number of PHY's. This configuration can lead to inefficiency in some situations. For example, a customer may deploy a system with one 12×DS3 PHY card to interconnect three DS3 links, and one 4×OC3 PHY card to interconnect an OC3 link. In such a configuration, nine DS3 and three OC-3 interfaces are idle, and the processing engines are under utilized. The back-plane design is more cost effective and more efficient when the system is configured to handle a large number of interfaces that have similar traffic pattern and physical type. For example, when the system is configured to aggregate residential Ethernet traffic from high-speed access networks (such as PON, DSL and FTTx), the back-plane design yields a lower per-port cost, and greater flexibility in handling over-provisioned traffic.

In a system that supports the mid-plane design, the PHYs and the processing engines are separated with an intermediate switch. The intermediate switch can be implemented as software, hardware, firmware, or a combination, using circuit, packet, analog, or digital switches, or any other appropriate technique. One type of switch implementation has been described in the Pooling Switch section above. The intermediate switch allows the users to direct data packets from any physical interface on the PHYs to any processing engine. The mid-plane design utilizes the packet processing components more efficiently. Since the packet processors are normally the most expensive elements of the system, the mid-plane design is more cost effective. The mid-plane design is particularly suitable for aggregating traffic from low-speed interfaces and providing service interworking.

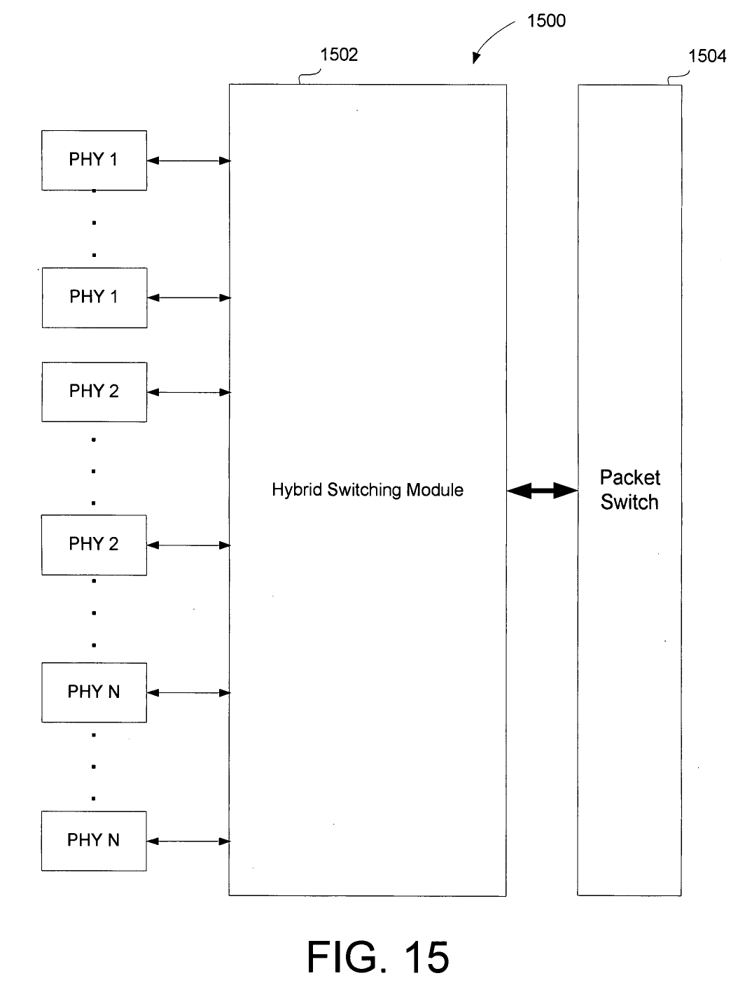

FIG. 15 is a block diagram illustrating a hybrid switching system embodiment. In the example shown, hybrid switching system 1500 may be a router, a switch, or other type of network switching system. The system includes N different types of physical interfaces (sometimes referred to as link interfaces), labeled PHY1-PHYN. These different types of physical interfaces have different service requirements such as data speed. Consequently, the requisite amount of resources for processing data transmitted and received on these physical interfaces varies. Each type of PHY includes one or more individual modules. Each physical interface module has one or more physical ports for transferring signals between the rest of the system and the transmission media. The physical interface modules are configured to transmit and receive one or more types of network traffic based on transmission protocols such as Ethernet, Gigabit Ethernet, Asynchronous Transfer Mode (ATM), Frame Relay, etc. over the physical ports. The physical interface modules are coupled to a hybrid switching module 1502, which in turn is coupled to a packet switch 1504. As will be shown in more detail below, the hybrid switching module is capable of transferring data between different types of physical ports via the packet switch, fulfilling the requirements associated with different types of traffic, and at the same time allowing for efficient processing resource management.

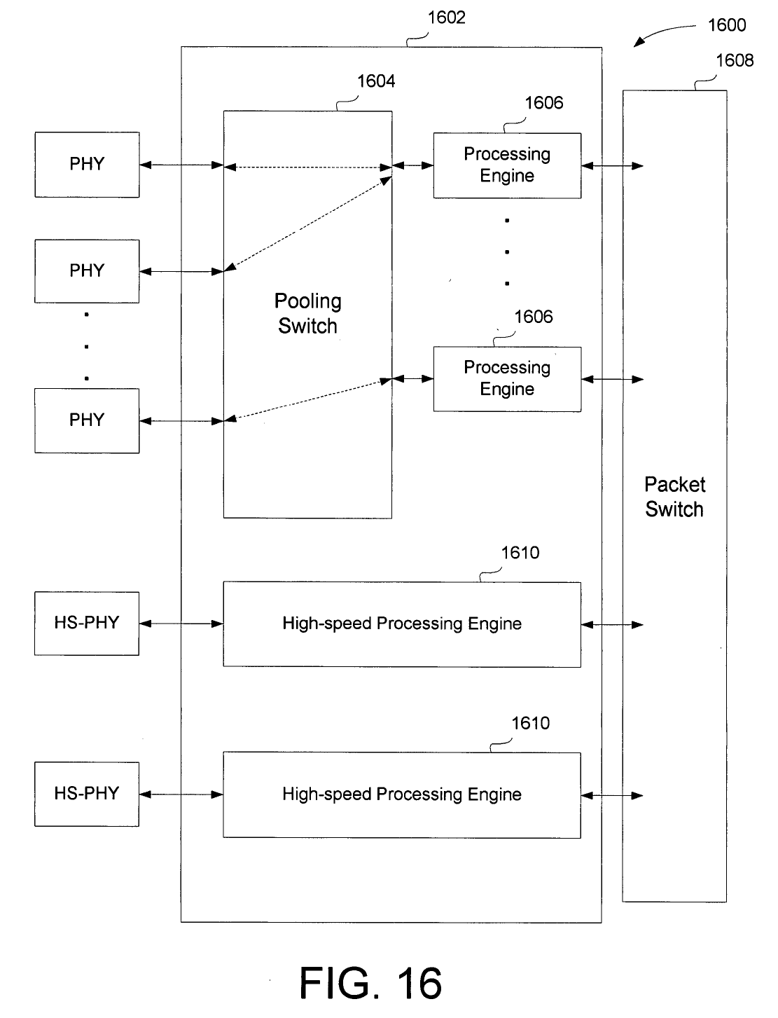

FIG. 16 is a block diagram illustrating an embodiment of a hybrid switching system. In the example shown, hybrid system 1600 combines a mid-plane design and a back-plane design. For purposes of illustration, system 1600 is shown to include two types of physical interface modules: low speed modules and high speed modules, labeled as PHY and HS-PHY, respectively. High speed and low speed are relative terms. In some embodiments, the high speed physical interface modules transfer data at a rate at least 10 times greater than the low speed physical interface modules. The data rate ratio of different types of physical interface modules can be different in other embodiments.

The physical interface modules are coupled to a hybrid switching module 1602. In this example, the hybrid switching module includes a pooling switch 1604. The pooling switch may be implemented using the above described Time Slot Interchange (TSI) switch. It is configured to transfer data to and from the PHY modules while efficiently managing the distribution of processing resources. The hybrid switching module further includes processing engines 1606, which are used to perform packet processing logic. The number of processing engines included in the system depends on implementation and may vary for different embodiments. The processing engines can be implemented as software, hardware, firmware, or a combination, using Application Specific Integrated Circuit (ASIC), Field Programmable Gate Array (FPGA), Network Processing Unit (NPU), general purpose processor, or any other appropriate techniques.

The hybrid switching module also includes high speed processing engines 1610, which process packets to and from the HS-PHY modules. To handle user traffic with greater efficiency, the high speed processing engines shown in this example are integrated with their corresponding HS-PHY modules. In some embodiments, the high speed processing engines and the HS-PHY modules are separate components. The processing engines as well as the high speed processing engines are coupled to a packet switch 1608, which includes a switch fabric. By using appropriate configuration information such as a switching table, the packet switch transfers data between different processing engines and high speed processing engines so that the packets are sent to the appropriate egress port.

The ingress packets received by the PHY interfaces are sent to pooling switch 1604 to be aggregated and groomed, and distributed to the processing engines. Techniques described in the Pooling Switch section above are used. The processing engines perform more computationally intensive processing tasks such as packet lookup and analysis, QOS, forwarding, etc. Each packet is sent to packet switch 1608, which switches the packet to the appropriate processing engine or high speed processing engine depending on the corresponding egress link for the packet. If the packet is switched to a processing engine, it is forwarded to the pooling switch and sent on the egress link interface of the appropriate PHY to be forwarded to the packet's destination. If the packet is switched to a high speed processing engine, it is sent on an egress HS-PHY interface coupled to the high speed processing engine.

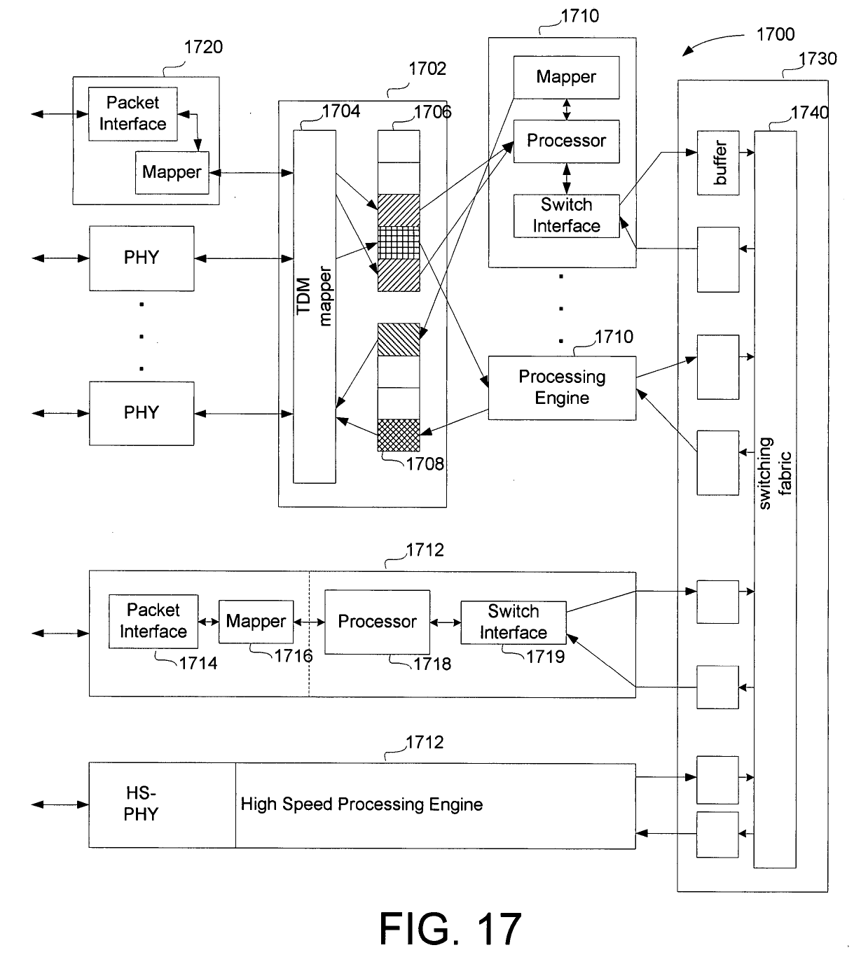

FIG. 17 is a block diagram illustrating an example of a hybrid switching system in greater detail. System 1700 supports data switching at different speeds. A portion of the system implements a mid-plane design for supporting traffic aggregation for services requiring comparatively lower transmission rate, and another portion of the system implements a back-plane design for supporting services requiring higher transmission rate.

In the example shown, the mid-plane portion includes PHY modules 1720. In some embodiments, the PHYs include multi-port interface modules for exchanging data with the physical transmission medium. The physical ports may support wired or wireless connections. The PHY modules support Layer 1 signaling standards such as DS1, DS3, OC3, etc. The PHY modules also include support for one or more Layer 2 data services such as Asynchronous Transfer Mode (ATM), Frame Relay, and Ethernet. In this example, the PHY modules support a maximum data rate of approximately 10 Mb/s to 45 Mb/s. The HS-PHY modules include interface modules supporting high speed Layer 1 signaling standards such as XAUI, SPI, etc. The HS-PHY modules are configured to support high speed Layer 2 data services such as Gigabit Ethernet or 10×Gigabit Ethernet. The HS-PHY modules support higher data rates, with a minimum of approximately 1 Gb/s in this example. Different maximum/minimum rates may be used in other embodiments. Each of the PHY and HS-PHY modules may operate at different speed ranges.

In the example shown, each of the PHYs and the HS-PHYs include a packet interface. Each PHY or HS-PHY use the packet interface to perform, among other things, Layer 1 operations such as analog-to-digital conversion, digital-to-analog conversion, modulation, demodulation, etc. The packet interface may also be configured to perform higher level operations such as Layer 2 processing. Each PHY may include a mapper used to translate data between different protocols. For example, data received via transmission protocols such as Frame Relay or ATM can be translated to a different protocol such as Ethernet, which is used to transfer data between components within the switch.

In the example shown, a pooling switch 1702 is used to aggregate and groom traffic and distribute processing load among the processing engines. In this example, the pooling switch includes a TDM mapper 1704 that maps the ingress data packets received on the PHYs to a set of time slots 1706. In some embodiments, buffers are used to store received data that correspond to the set of time slots. The TDM mapper is implemented according to the appropriate TDM transmission protocol employed. As described previously, in some embodiments the TDM mapper forwards ingress data received according to the set of time slots to a respective processing engine in the form of GFP framed data over SONET. Other mapping schemes are used in different embodiments.

The time slots are mapped to processing engines 1710. More than one time slot may be mapped to the same processing engine. Data received on a time slot is forwarded to a corresponding processing engine for processing. In some embodiments, the time slot to processing engine mapping is based on system configuration. In some embodiments, the mapping is determined based on the total amount of traffic to be handled by the processing engines and/or total amount of processing required, and is adjusted dynamically to load-balance the processing engines. Each of the processing engines and the high speed processing engines includes a processor and a switch interface. Each processor carries out layer 2 and above packet processing functions such as QoS, packet inspection and analysis, virtual channel mapping, etc. Ingress data is forwarded via the switch interface to packet switch 1730. An example of an ingress data flow via a pooling switch and a processing engine is shown in FIG. 2A.

High speed data received on packet interface 1714 of a HS-PHY is protocol mapped by a mapper 1716, processed by a processor 1718, and sent to the packet switch on switch interface 1719. In some embodiments, mapper 1716 performs a physical interface conversion, such as SPI to XAUI interface conversion.

The data received by the packet switch is buffered and transferred via switch fabric 1740 to an appropriate egress buffer. In the example shown, each egress buffer serves a corresponding processing engine/high speed processing engine. Other buffering schemes may be used in various embodiments. The data is sent to a processing engine 1710 or a high speed processing engine 1720 depending on the required egress link. An example of an egress data flow via a processing engine and pooling switch is shown in FIG. 2B.

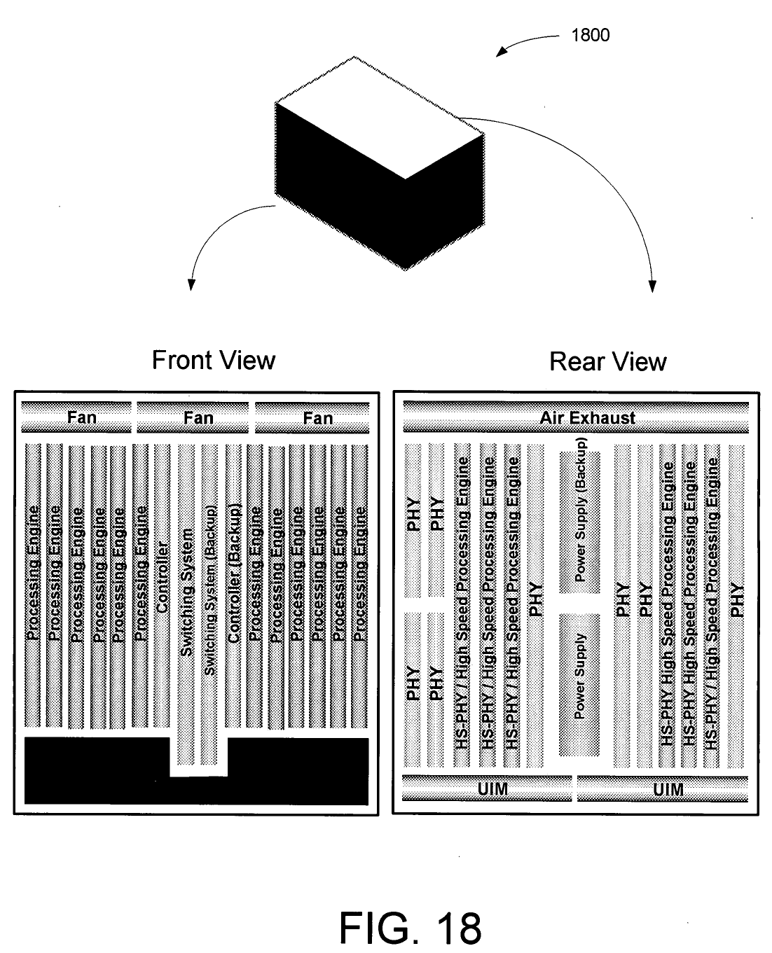

FIG. 18 is a layout diagram illustrating an example layout of a hybrid switching system embodiment. The components of system 1800 shown in the example are similar to system 1600 described in FIG. 16 previously. Many physical layouts are possible for the same system. In this example, system 1800 includes a number of slots in which modules supporting various functions are inserted. On the front side of system 1800 are slots for inserting modules that provide the physical ports (both PHYs and HS-PHYs). An HS-PHY and its corresponding high speed processing engine are implemented on the same module. On the back side of the system are slots for inserting modules that provide the processing engines for data to and from the PHYs. The packet switch is also shown to be inserted on this side. Within the device, the modules are interconnected via buses. In some embodiments, the configuration shown in FIG. 8 is used for the mid-plane portion of the system. The back-plane portion, which includes the HS-PHY and high speed processing modules, allow the modules to be coupled to the data plane directly.

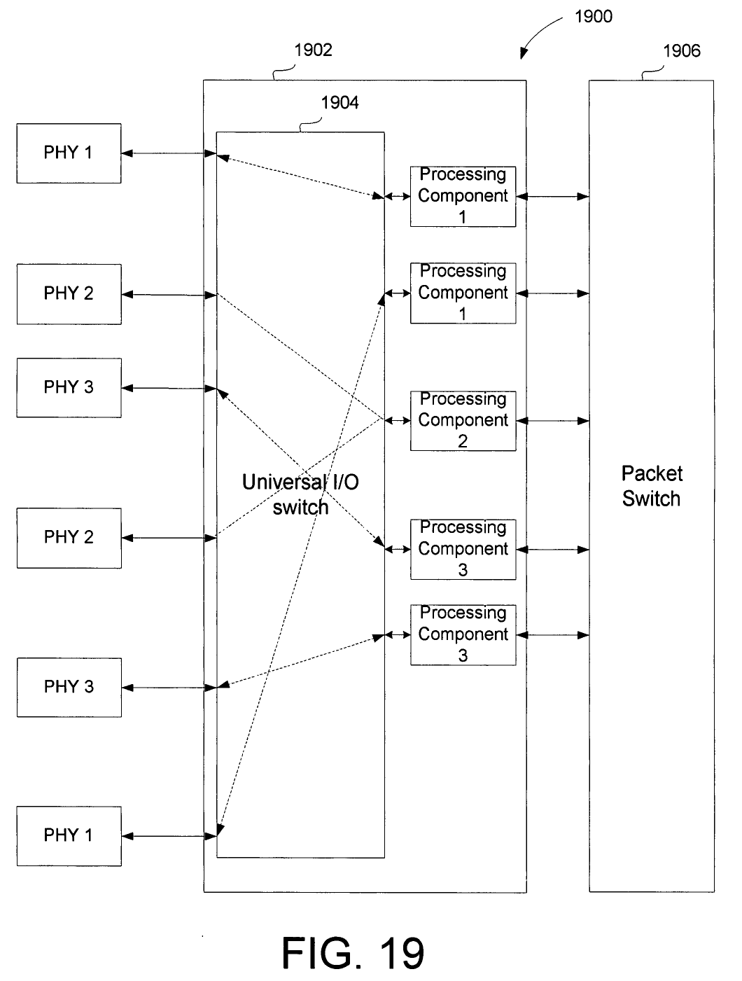

FIG. 19 is a block diagram illustrating another embodiment of a hybrid switching system. In system 1900, several types of physical interface modules (labeled PHY1, PHY2, PHY3) are coupled to a hybrid switching module 1902. The hybrid switching module includes a universal I/O switch 1904, which is coupled to each of the physical interface modules. Data streams received on different types of physical interface modules have different requirements such as transmission speed, priority level, packet type, protocol process, etc.

Hybrid switching modules 1902 includes several types of processing components labeled Processing Component 1, Processing Component 2, and Processing Component 3, which are designed to fulfill the specific requirements of traffic handled by PHY1, PHY2, and PHY3, respectively. Additional physical interface module/processing component types may be used. A single processing component can handle traffic received on multiple PHYs, and traffic received on a single PHY may be directed to multiple processing components. The physical interface modules and the processing components are coupled to a universal I/O switch 1904. The universal I/O switch 1904 is configurable to direct traffic between the physical interface modules and the processing components, so that appropriate mapping between the physical interface modules and the processing components is obtained and the requirements of the data streams are fulfilled. The resulting switching system is a more flexible one, since the same physical interface slot on the device can be used by different types of physical interface modules.

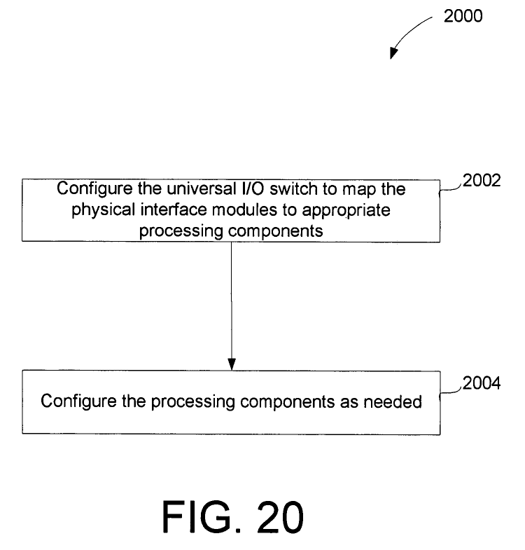

FIG. 20 is a flowchart illustrating an embodiment of a process for configuring a hybrid switching system. Process 2000 shown in this example may be performed manually by an operator, or automatically by a computer program. Steps in process 2000 may be performed in a different order than what is shown. During the process, the universal I/O switch is configured to map the physical interface modules to appropriate processing components (2002). Each of the processing components is optionally configured as needed (2004). For example, if a processing component includes a pooling switch, the time slot to processing engine mapping is configured.

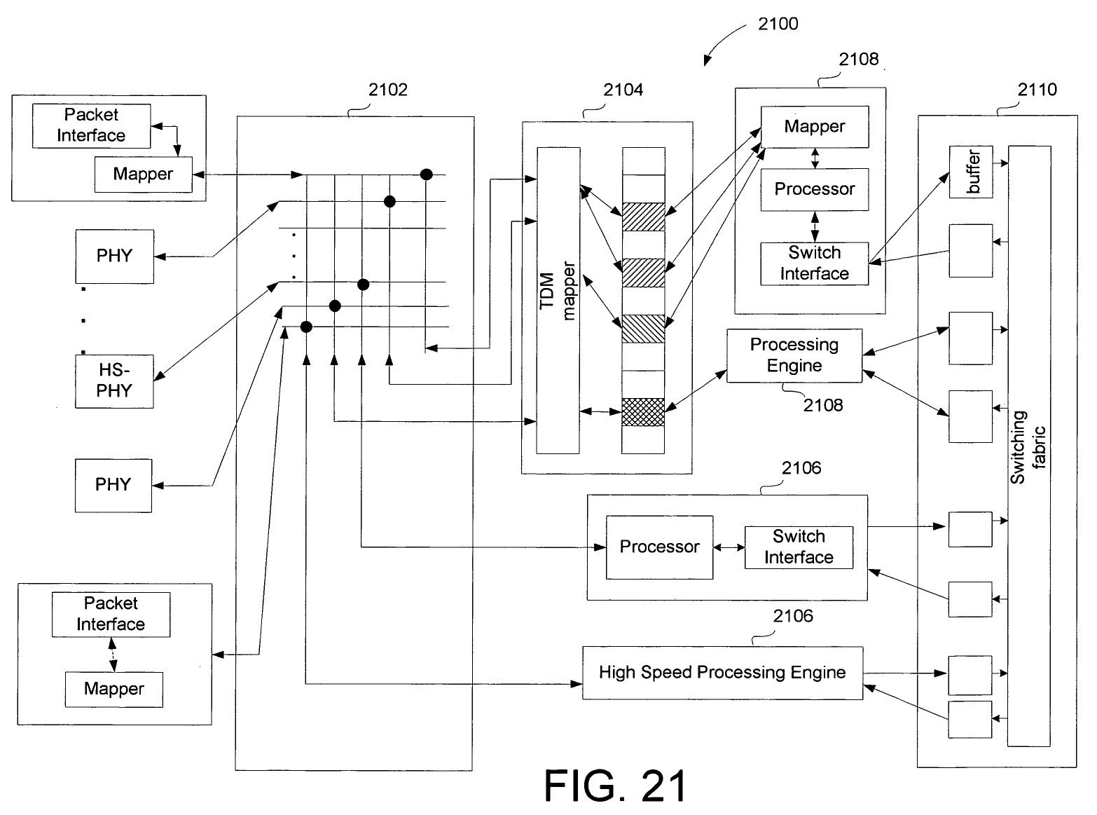

FIG. 21 is a block diagram illustrating in greater detail an embodiment of a hybrid switching system that includes a universal I/O switch. In this example, system 2100 includes two types of physical interface modules, PHYs configured to handle low speed traffic and HS-PHYs configured to handle high speed traffic.

Each PHY/HS-PHY includes a packet interface and a mapper. The output of the physical interface modules are coupled to the inputs of the universal I/O switch 2102, implemented using a crossbar switch (also referred to as a matrix switch). The crossbar switch includes a set of input terminals, and a set of output terminals. The input and output terminals include conductive material such as metal wires. An input terminal may be connected to any output terminal. In the example shown, the input and output terminals are laid out in a grid. At each cross point on the grid there is a switch, which may be implemented mechanically or electrically. When the switch is in closed position, the corresponding input terminal and output terminal are connected. Although the crossbar switch can be configured to switch any of its inputs to any of its outputs, the configuration of the switches is sometimes subject to certain rules. For example, it may be disallowable to connect two inputs to the same output.

The outputs of the universal I/O switch are coupled to a pooling switch 2104, and one or more high speed processing engines 2106. As described previously, the pooling switch allows resource pooling of one or more low speed processing engines 2108 for processing data sent or received on PHYs, which have lower speed requirements. High speed data sent or received on each HS-PHY is handled by a corresponding high speed processing engine. The crossbar switch can be configured to direct data received on any PHY to the pooling switch and data received on any HS-PHY to a dedicated high speed processing engine, regardless of the location of the specific physical interface module. A packet switch 2110 is used to direct ingress data to the appropriate egress processing engine, so that the data is eventually sent to the appropriate egress link.

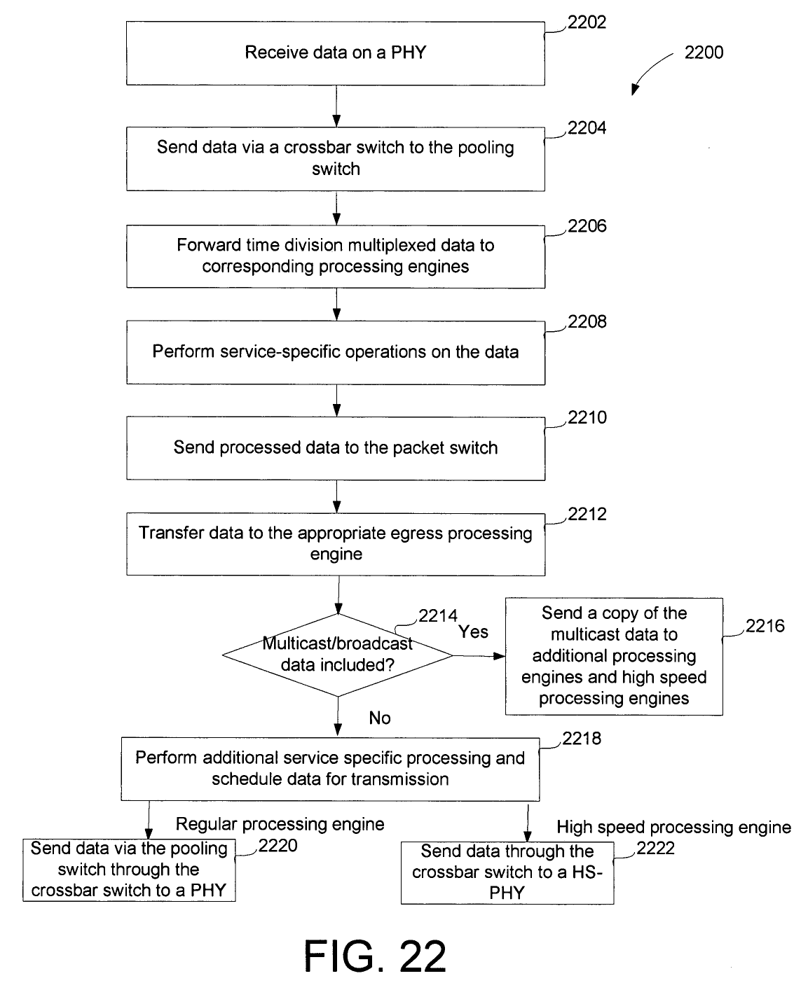

FIG. 22 is a flowchart illustrating an embodiment of a process for data flow through the hybrid switching system 2100. In this example, process 2200 initiates when data is received on a PHY (2202). The data is sent via a crossbar switch to the pooling switch (2204). The pooling switch performs time division multiplexing and sends data received on various time slots to one or more corresponding processing engines (2206). The processing engines perform various service-specific operations on the data (2208). The same processing engine may process data received on different PHYs and aggregated by the pooling switch. Processed data is sent by the processing engine to the packet switch (2210). The packet switch transfers the data to the appropriate egress path by selecting an egress processing engine that may be a low speed or a high speed processing engine. The data is transferred to the appropriate egress processing engine (2212). It is determined whether the data includes multicasting or broadcasting data (e.g. IP or Ethernet multicast data) (2214). If yes, a copy of the multicasting/broadcasting data is sent to additional processing engines and high speed processing engines (2216). Once the egress processing engine receives the data, it performs additional service specific operations and schedules the data for transmission (2218). If the egress processing engine is a low speed processing engine, the data is sent via the pooling switch through the crossbar switch to a PHY (2220). If the egress processing engine is a high speed processing engine, it is sent via the crossbar switch to an HS-PHY (2222).

Data received by an HS-PHY is sent via the crossbar switch to a high speed processing engine. The rest of the data flow process is similar to process 2200, steps 2208-2222. Data received on an ingress HS-PHY may be sent to an egress interface that is either an HS-PHY or a PHY.

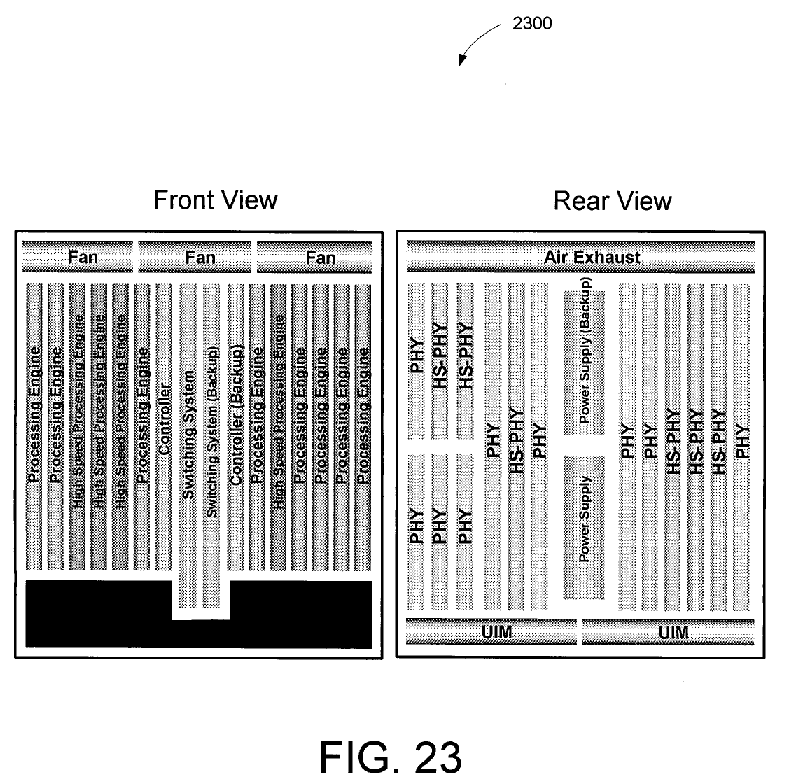

FIG. 23 is another layout diagram illustrating an example layout of another hybrid system embodiment. In this example, system 2300 includes components that are similar to the ones included in system 2100 described in FIG. 21. A number of physical layouts exist for the system. In the example shown, the PHYs and HS-PHYs are plugged into slots on one side of the device. The slots have various widths so that cards supporting different number of physical ports can be used. The processing engines and high speed processing engines are plugged into slots on the opposite side of the system. The switching system card includes the packet switch, the pooling switch, and the universal I/O switch. Each of the slots accepts either a PHY card or an HS-PHY card. By configuring the crossbar switch, the operators have the flexibility to direct traffic from different types of physical ports into low speed processing engines or into high speed processing engines.

Network traffic processing via a hybrid switching system has been disclosed. For purposes of illustration, several system embodiments that involve PHYs and their corresponding processing engines, and HS-PHYs and their corresponding high speed processing engine are shown in various examples. Additional types of physical interface modules and processing engines may be used in other embodiments.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A data networking system, comprising:
a physical interface module of a first type, configured to transfer data traffic that meets a first requirement;
a physical interface module of a second type, configured to transfer data traffic that meets a second requirement, the second requirement being different from the first requirement;
a packet switch; and
a hybrid switching module configured to transfer data between the first physical interface module and the packet switch, and to transfer data between the second physical interface module and the packet switch.

2. A system as recited in claim 1, wherein the first requirement is associated with a data rate requirement.

3. A system as recited in claim 1, wherein the first requirement is associated with a first data rate, the second requirement associated with a second data rate, and the second data rate is higher than the first data rate.

4. A system as recited in claim 1, wherein the hybrid switching module includes a universal I/O switch coupled to the physical interface module of the first type and the physical interface module of the second type.

5. A system as recited in claim 4, wherein the universal I/O switch is a crossbar switch.

6. A system as recited in claim 1, wherein the physical interface module of the first type is one of a plurality of physical interface modules of the first type, and the hybrid switching module includes a pooling switch coupled to the plurality of physical interface modules of the first type.

7. A system as recited in claim 6, wherein the hybrid switching module further includes a processing engine coupled to the pooling switch.

8. A system as recited in claim 1, wherein:
the physical interface module of the first type is one of a plurality of physical interface modules of the first type;
the hybrid switching module includes:
a universal I/O switch coupled to the plurality of physical interface modules of the first type and the physical interface module of the second type;
a first plurality of processing engines configured to process data traffic to and from the plurality of physical interface modules of the first type; and
a pooling switch coupled to the universal I/O switch and the plurality of processing engines.

9. A system as recited in claim 8, wherein:
the physical interface module of the second type is one of a plurality of physical interface modules of the second type; and
the hybrid switching module further includes a second plurality of processing engines configured to process data traffic to and from the plurality of physical interface modules of the second type.

10. A method of transferring network data via a data networking system, comprising:
receiving data traffic on a physical interface module of a first type, the physical interface module being configured to transfer data traffic that meets a first requirement;
receiving data traffic on a physical interface module of a second type, the physical interface module being configured to transfer data traffic that meets a second requirement, the second requirement being different from the first requirement;
transferring the data traffic received on the physical interface module of the first type and the data traffic received on the physical interface module of the second type via a hybrid switching module to a packet switch.

11. A method as recited in claim 10, wherein the first requirement is associated with a data rate requirement.

12. A method as recited in claim 10, wherein the first requirement is associated with a first data rate, the second requirement is associated with a second data rate, and the second data rate is higher than the first data rate.

13. A method as recited in claim 10, wherein transferring the data traffic via the hybrid switching module includes transferring the data traffic via a universal I/O switch coupled to the physical interface module of the first type and the physical interface module of the second type.

14. A method as recited in claim 13, wherein the universal I/O switch is a crossbar switch.

15. A method as recited in claim 10, further comprising receiving data traffic on a plurality of physical interface modules of the first type, and sending the data traffic to a pooling switch coupled to the plurality of physical interface modules of the first type.

16. A method as recited in claim 15, further comprising sending the data traffic from the pooling switch to a processing engine.

17. A method as recited in claim 10, wherein:
the physical interface module of the first type is one of a plurality of physical interface modules of the first type;
the hybrid switching module includes:
a universal I/O switch coupled to the plurality of physical interface modules of the first type and the physical interface module of the second type;
a first plurality of processing engines configured to process data traffic to and from the plurality of physical interface modules of the first type; and
a pooling switch coupled to the universal I/O switch and the plurality of processing engines.

18. A method as recited in claim 17, wherein:
the physical interface module of the second type is one of a plurality of physical interface modules of the second type; and
the hybrid switching module further includes a second plurality of the plurality of processing engines configured to process data traffic to and from the plurality of physical interface modules of the second type.

19. A method of configuring a hybrid data networking system that includes a universal I/O switch, a physical interface module of a first type configured to transfer data traffic that meets a first requirement, a physical interface module of a second type configured to transfer data traffic that meets a second requirement, and a plurality of processing engines, comprising:
configuring the universal I/O switch to map the physical interface module of the first type to a first appropriate one of the plurality of processing engines;
configuring the universal I/O switch to map the physical interface module of the second type to a second appropriate one of the plurality of processing engines;
configuring the first and second appropriate ones of the processing components such that the physical interface module of the first type meets the first requirement and the physical interface module of the second type meets the second requirement.
